(19) United States
(12) Patent Application Publication
(10) Pub. No.: US 2005/0149567 A1
(43) Pub. Date: Jul. 7, 2005

(54) Method and apparatus for selecting a jury

(76) Inventors: Martin Levin, Pensacola, FL (US); Fred Levin, Gulf Breeze, FL (US); Shane Lincke, Pace, FL (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/980,814

(22) Filed: Nov. 4, 2004

Related U.S. Application Data
(63) Continuation-in-part of application No. 10/263,821, filed on Oct. 4, 2002.
(60) Provisional application No. 60/410,005, filed on Sep. 12, 2002.

(51) Int. Cl. G06K 9/00; G06F 17/00; G06F 17/30; G06F 7/00; G06F 17/60

(52) U.S. Cl. 707/104.1; 707/6; 705/1

(57) ABSTRACT

A selection system for selecting at least one candidate from a group of potential candidates includes a survey database, a candidate database, and a processor. The survey database is configured to store statistical date. The candidate database is configured to store potential candidate information regarding at least one candidate. The processor may be in communication with the survey database and the candidate database. The processor may also be configured to perform a comparison between the statistical data and the candidate information and select at least one candidate from a group of potential candidates based upon the comparison.

### REFERENCE TO RELATED APPLICATIONS

This application is a continuation-in-part of U.S. application Ser. No. 10/263,821, filed on Oct. 4, 2002, which claims priority from U.S. Provisional Patent Application Ser. No. 60/410,005, filed on Sep. 12, 2002. The above-referenced applications are hereby incorporated by reference in their entirety.

### BACKGROUND OF THE INVENTION

1. Field of the Invention

This invention relates to a system and method for automatically and objectively selecting members of a jury. The invention is also directed to computer programs and methods for dynamically monitoring and recording courtroom events and potential jurors' behavior and responses and for dynamically selecting members of a jury.

2. Description of the Related Art

The jury selection process is one of the most critical aspects of a trial, because the jurors will ultimately decide a defendant's guilt or innocence. However, during a jury selection process, there are numerous tasks that each party must perform and monitor simultaneously in order to select the members of the jury. During the voir dire process, each party wishes to devise a strategy that will allow them to assemble a jury panel that is most favorable to their parties' interest. Each party must conduct an examination of each potential juror, assess each juror's ability to be objective to their party and challenge any juror whom cannot render an unbiased opinion to their party. Once the judge or presiding authority initiates the jury selection process, each party is required to perform these tasks while gathering a large amount of data within a short amount of time at a very fast pace.

Accordingly, new and improved systems and methods for monitoring and recording courtroom events in order to assist each party in selecting the members of the jury are needed.

### SUMMARY OF THE INVENTION

According to an embodiment of the invention, provided is a selection system for selecting at least one candidate from a group of potential candidates. The selection system includes a survey database, a candidate database and a processor. The survey database is configured to store statistical data. The candidate database is configured to store potential candidate information regarding at least one candidate. The processor communicates with the survey database and the candidate database. The processor is configured to perform a comparison between the statistical data and the candidate information and select at least one candidate from a group of potential candidates based upon the comparison.

According to another embodiment of the invention, provided is a method of using a computer to select at least one candidate from a group of potential candidates. The method includes the steps of storing statistical data and storing potential candidate information regarding at least one candidate. The method also includes the step of processing the statistical data and the potential candidate information to perform a comparison between the statistical data and the candidate information. The method further includes the step of selecting at least one candidate from a group of potential candidates based upon the comparison.

According to a further embodiment of the invention, a selection system for selection of at least one candidate from a group of potential candidates is provided. The selection system includes first storing means, second storing means, processing means and selecting means. The first storing means stores statistical data. The second storing means stores potential candidate information regarding at least one candidate. The processing means processes the statistical data and the potential candidate information to perform a comparison between the statistical data and the candidate information. The selecting means selects at least one candidate from a group of potential candidates based upon the comparison.

### BRIEF DESCRIPTION OF THE DRAWINGS

The objects and features of the invention will be more readily understood with reference to the following description and the attached drawings, wherein:

FIG. 1A is a block diagram of a system according to an embodiment of the invention;

FIG. 1B is a flowchart of a pre-selection preparation method according to an embodiment of the invention;

FIG. 1C is a block diagram of establishing a communication with a survey database according to an embodiment of the invention;

FIG. 1D is an illustration of a survey table maintained as a survey database according to an embodiment of the invention;

FIG. 2 is a block diagram of a main interface according to an embodiment of the invention;

FIG. 3 is a block diagram of a create new case interface according to an embodiment of the invention;

FIG. 4 is a flowchart of a jury selection process according to an embodiment of the invention;

FIGS. 5A-5C are block diagram of a case question interface according to an embodiment of the invention;

FIG. 6 illustrates a block diagram of a potential jurors interface according to an embodiment of the invention;

FIG. 7 depicts a seating chart configuration interface according to an embodiment of the invention;

FIG. 8 shows a juror seat assignment interface according to an embodiment of the invention;

FIG. 9 is a block diagram of juror answer mode interface according to an embodiment of the invention;

FIGS. 10A-10C show a main case interface according to an embodiment of the invention;

FIG. 11 illustrates features that may be included in the main interface according to an embodiment of the invention;

FIGS. 12A-12F depict a create new case interface according to an embodiment of the invention;

FIGS. 13A-13B shows a configure case interface according to an embodiment of the invention;

FIGS. 15A-15E illustrate one or more question databases that may be employed according to an embodiment of the invention;

FIGS. 16A-16C depict a potential jurors interface according to an embodiment of the invention;

FIGS. 17A-17B illustrate a seating chart that may be generated in the seating chart configuration interface according to an embodiment of the invention;

FIGS. 18A-18B illustrate the assignment of the seating position in the assign seats interface according to an embodiment of the invention;

FIGS. 19A-19J illustrate exemplary interactive display screens according to an embodiment of the invention;

FIG. 20 depicts a print interface according to an embodiment of the invention;

FIG. 21 illustrates an example of the type of information that may be displayed visually on a display screen according to an embodiment of the invention;

FIG. 22 shows a cause alert interface according to an embodiment of the invention; and

FIG. 23 depicts a print preview of a juror profile according to an embodiment of the invention.

### DETAILED DESCRIPTION OF THE PREFERRED EMBODIMENTS

The invention relates to, according to one embodiment, a method and apparatus for objectively and dynamically selecting members from a group utilizing a real-time selection process management system. For instance, the invention may be employed as a jury selection management system 200 to dynamically select jurors from a potential juror pool.

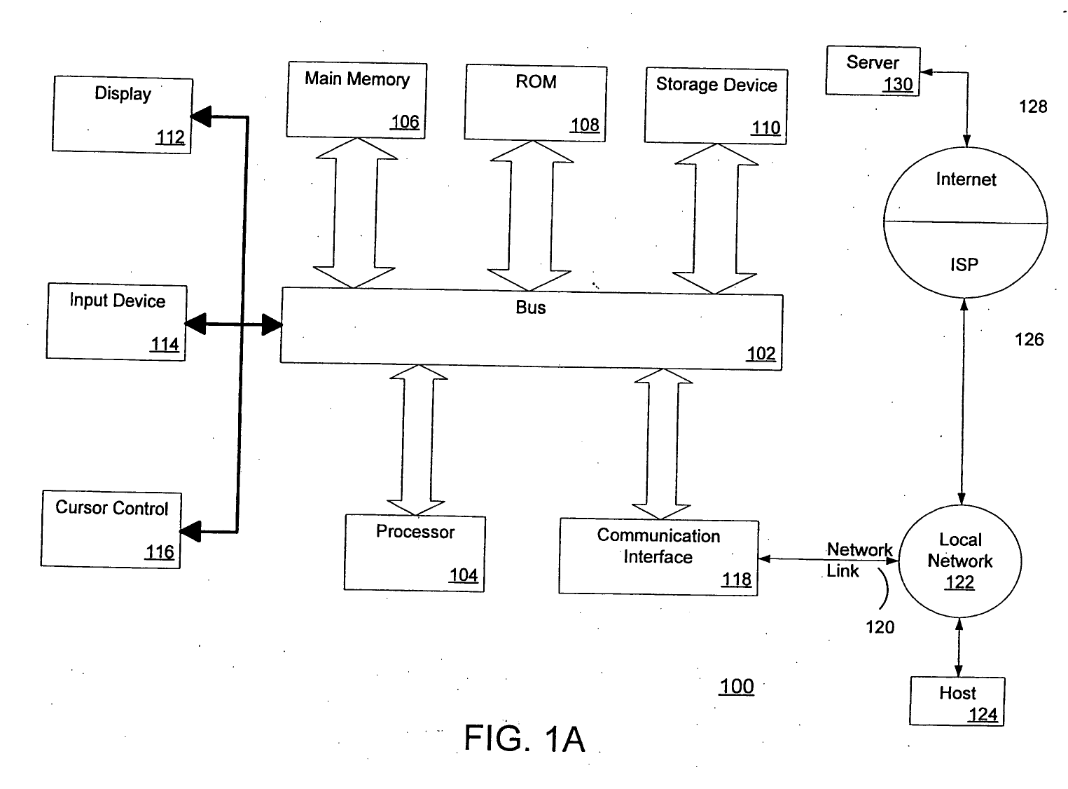

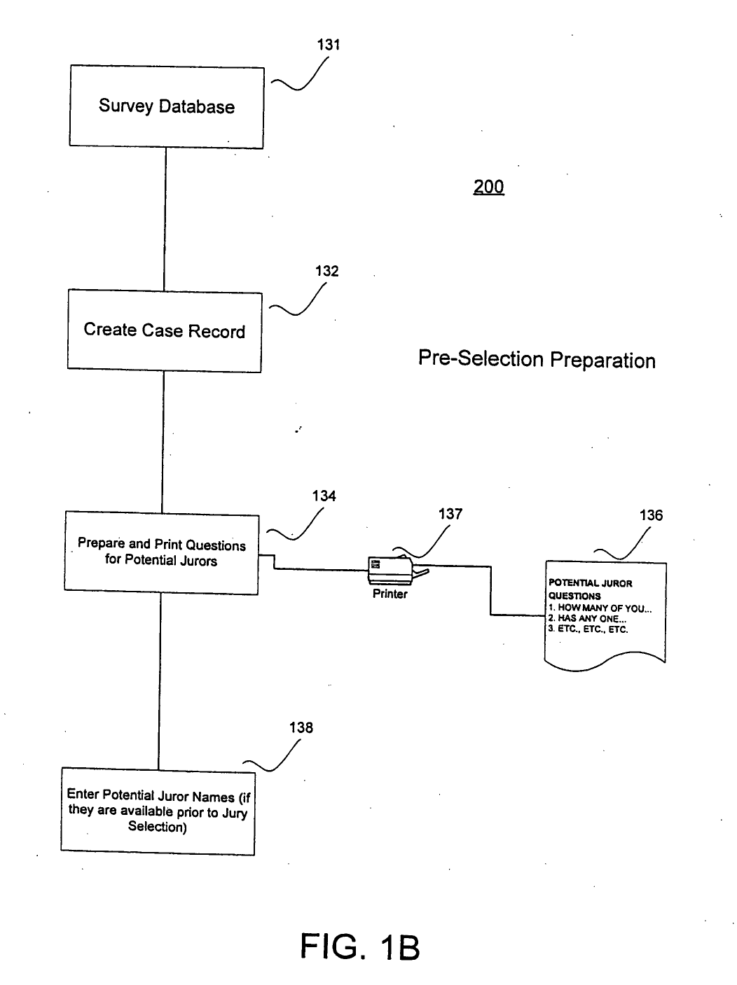

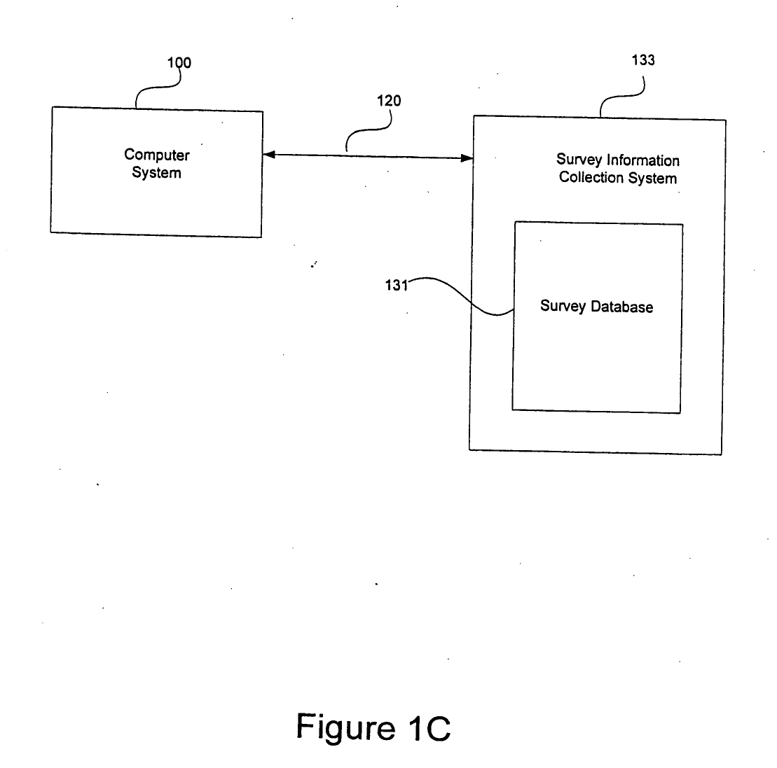

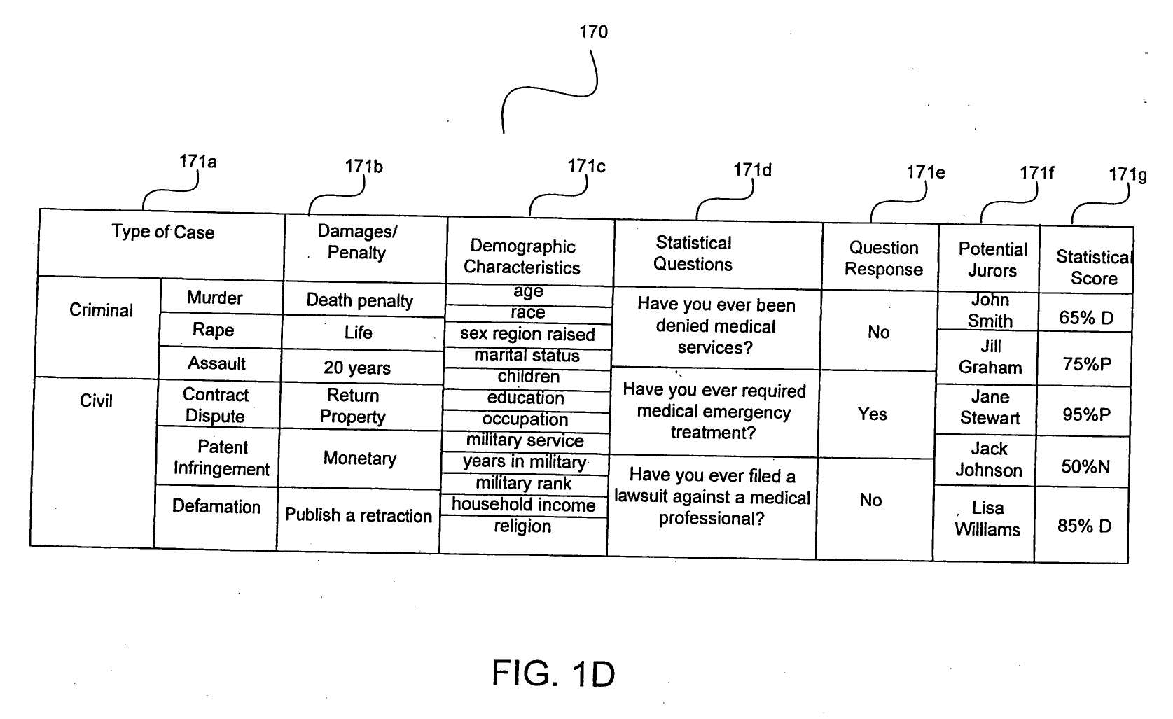

FIG. 1A is a block diagram that illustrates a computer system 100 upon which an embodiment of the invention may be implemented. Computer system 100 may include a bus 102 or other communication mechanism for communicating information, and a processor 104 coupled with bus 102 for processing information. Computer system 100 may also include a main memory 106, such as a random access memory (RAM) or other dynamic storage device, coupled to bus 102 for storing information and instructions to be executed by processor 104. Main memory 106 also may be used for storing temporary variable or other intermediate information during execution of instructions to be executed by processor 104. Computer system 100 may further include a read only memory (ROM) 108 or other static storage device coupled to bus 102 for storing information and instructions for processor 104. A storage device 110, such as a magnetic disk or optical disk, may be provided and coupled to bus 102 for storing information and instructions.

Computer system 100 may be coupled via bus 102 to a display 112, such as a cathode ray tube (CRT) or flat panel display, for displaying information to a computer user. An input device 114, including alphanumeric and other keys, voice-activated and/or touch-sensitive screens, may be coupled to bus 102 for communicating information and command selections to processor 104. Another type of user input device may be a cursor control 116, such as a mouse, a trackball, or cursor direction keys for communicating direction information and command selections to processor 104 and for controlling cursor movement on display 112.

According to one embodiment of the invention, the jury selection management system may be provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 may cause processor 104 to perform the process steps described herein. One or more processors in a multi-processing arrangement may also be employed to execute the sequences of instructions contained in place of or in combination with software instructions to implement the invention. Thus, embodiments of the invention are not limited to any specific combination of hardware circuitry and software.

The term “computer-readable medium” as used herein may refer to any medium that participates in providing instructions to processor 104 for execution. Such a medium may take many forms, including, but not limited to, non-volatile media, volatile media, and transmission media. Non-volatile media may include, for example, optical or magnetic disks, such as storage device 110. Volatile media may include dynamic memory, such as main memory 106. Transmission media may include coaxial cables, copper wire, and fiber optics, including the wires that comprise bus 102. Transmission media can also take the form of acoustic or light waves, such as those generated during radio frequency (RF) and infrared (IR) data communications. Common forms of computer-readable media may include, for example, floppy disk, a flexible disk, hard disk, magnetic tape, any other magnetic medium, a CD-ROM, DVD, any other optical medium, punch cards, paper tape, any other physical medium with patterns of holes, a RAM, a Programmable read-only memory (PROM), an erasable programmable read-only memory (EPROM), a FLASH-EPROM, any other memory chip or cartridge, a carrier wave as described hereinafter, or any other medium which a computer can read.

Computer system 100 may also include a communication interface 118 coupled to bus 102. Communication interface 118 may provide a two-way data communication coupling to a network link 120 that may be connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented in the invention. In any such implementation, communication interface 118 may send and receive electrical, electromagnetic, or optical signals that carry digital data streams representing various type of information.

Network link 120 may provide data communication through one or more networks to other data devices. For example, network link 120 may provide a connection through network 122 to a host computer 124 or to data equipment operated by an Internet Service Provider (ISP) 126. ISP 126 in turn may provide data communication services through the worldwide packet data communication network, also referred to as the “Internet” 128. Local network 122 and Internet 128 may both use electrical, electromagnetic, or optical signals that carry digital data streams. The signals through the various networks and the signals on network link 120 and through communication interface 118, which carry the digital data to and from computer system 100, are exemplary forms of carrier waves transporting the information. Network link 120 may also communicate with devices such as personal digital assistants (PDAs), Tablet PCs, data enabled phones and wireless devices.

Computer system 100 can send messages and receive data, including program codes, through the network(s), network link 120, and communication interface 118. In the Internet example, a server 130 may transmit a requested code for an application program through Internet 128, ISP 126, local network 122, and/or communication interface 118.

FIG. 1B provides an exemplary outline of a general overview of some of the tasks that a user may use the jury selection management system 200 to implement prior to the jury selection process. For example, in the pre-selection preparation stage, a user may access a survey database (Step 131) by establishing a connection with a survey information collection system 133, the user may create a case record (Step 132), prepare and print questions for the potential jurors (Steps 134-136) and enter the potential juror names and other relevant information (Step 138), if available.

FIG. 1C provides an exemplary illustration of the survey database 131 and the survey information collection system 133 in communication with computer system 100 via network link 120 and/or communication interface 118. Computer system 100 may include a client computer residing at the user's premises. The client computer may represent many types of computing devices, such as a desktop personal computer, a portable computers, hand held computers, pagers, Web-phones, and other devices for communicating over a computer network such as the Internet. Although, in this embodiment, the survey database 131 is shown as residing on a separate network system, the survey database 131 and survey information collection system 133 may reside and run on computer system 100.

The survey database 131 is a database that collects statistical information to predict whether a person who responds to questions stored within the survey database 131 shows a bias towards one side of a dispute that will influence how the respondent will vote when determining the outcome of the dispute or issue at hand. Of particular interest in this system is a technique for automatically and objectively selecting members of a jury. In this embodiment, the survey database 131 may be a database that collects and stores survey information that may assist a user in determining whether a potential juror has a propensity to favor either the defendant or the plaintiff. The survey database 131 is a software-based survey information collection system 133 that constructs surveys. The surveys may be conducted in several manners, for example, through online voting conducted over the Internet, and/or through manual collection of the information where the information is entered into the survey information collection system 133 manually and through a telephone survey. These are merely exemplary. Other methods of entering the survey data are within the scope of the invention. The survey information collection system 133 may also include a simple computer network system having a computer. The computer may represent many types of computing devices, such as a desktop personal computer, a portable computers, hand held computers, pagers, Web-phones, and other devices for communicating over a computer network such as the Internet.

The survey information collection system 133 may enable a programmer or any user to gather and store the survey information. The survey information may be stored in the survey database 131. To aid in the selection of the jury members, a comparison may be performed between the information stored in the survey database 131 and the demographic information of each potential jurors and/or the responses provided by the potential jurors. The survey information may be collected and stored in the survey database 131 prior to the initiation of the jury selection process. Alternatively and conjunctively, the survey information may be constructed by polling a shadow jury at a remote location during the jury selection process.

FIG. 1D illustrates a table 170 which represents an embodiment of the survey database 131. The table 170 may include a type of case field 171a, a type of damages or penalty field 171b, a demographic field 171c, a statistical question field 171d, a question response field 171e, a potential juror field 171f and a statistical score field 171g. Each row may be constructed to include multiple rows. Some of the fields may be filled automatically, while other fields contain data that may be entered by the user. Some of the fields may be entered during the pre-selection phase of the jury selection process. However, any responses provided by a potential juror during the voir dire that contradicts or modifies the information stored during the pre-selection may override the presently entered information. Table 170 is capable of assessing the information stored in one or more fields and cumulating at least one or more statistical score or statistical total based upon the information stored in the fields of table 170. The statistical score or statistical total is capable of determining whether a potential juror has the propensity to favor either the plaintiff or the defendant depending upon the facts of the case. The survey information collection system 133 is also capable of sorting and arranging the information stored within any field in Table 170. The survey information collection system 133 may include a processor for performing certain network functions such as compiling, assembling, translating, computing and controlling data.

The type of case field 171a may be programmed to list the classification of the lawsuit and the charges and/or allegations asserted to support the basis of the lawsuit. For example, a legal case may be classified as either a criminal case or a civil case. A criminal case may be further classified based upon the case type. In a criminal case, the case type may include one or more charges which are asserted against the defendant, for example, a charge of murder, rape and/or assault. In a civil case, a plaintiff may bring a lawsuit against a defendant in a case type where the plaintiff alleges, for example, a breach of contract, patent infringement and/or defamation.

The survey database 131 may be configured to receive and store the type of damages or penalty information to determine how the respondents to the survey indicated that they would vote to determine the verdict of the lawsuit. The type of damages or penalty field 171b may be configured to list the type of restitution that is being sought within the legal case. A federal court or a state court may seek restitution, in a criminal case, against an offender by requiring the criminal to repay, as condition of his sentence, the victim or society in money or services. As restitution for a crime, a state court or a federal court may wish to sentence the criminal offender, for example, to 20 years in prison, life in prison or the death penalty. In a civil case, a plaintiff may seek restitution from a defendant, for instance, in the form of monetary damages, the performance of a course of action or the return of property.

The demographic field 171c may be configured to hold a listing of demographic characteristics that are relevant to determining how a potential juror will vote in a lawsuit. The demographic characteristics may be characterized as selection parameters. The survey information collection system 133 may be configured so that, based upon information selected in the type of field 171a and the type of damages/penalty field 171b, at least one or more selection parameters from the demographic characteristics may be selected and scored. The demographic characteristics may include factors such as age, race, sex, region raised, marital status, children, education, occupation, military service, years in military, military rank, household income, religion, monthly church attendance, political voting history, civil jury experience, criminal jury experience and jury foreperson experience. The survey information collection system 133 may determine that the selection parameters that may have the most influence on the verdict for a particular legal case are, for example, race, age and the region in which the potential juror is raised. Namely, the processor within the survey information collection system 133 calculates totals of and percentages of each demographic characteristics using the data stored in Table 170. Based upon this calculation, the system ranks and sorts the demographic characteristics. Then, the survey information collection system 133 selects the selection parameters that may have the greatest influence on the outcome of the lawsuit.

Based upon the type of case, the damages/penalties requested by the plaintiff or prosecutor and the juror's demographic information, the survey information collection system 133 may be further configured to determine which questions contained within the statistical question field 171d are most relevant in determining how each potential juror will vote to determine the verdict of the case. In a medical malpractice case, for example, where the defendant is being sued for negligence and the potential juror is a 44-year-old female, the survey information collection system 133 may rank the questions so as to indicate to the user to ask the potential juror “Have you ever been denied medical services?” “Have you ever required medical emergency treatment?” and “Have you ever filed a lawsuit against a medical professional?” The survey information collection system 133 also assigns a score to and ranks the relevant statistical questions. In other words, the processor calculates totals of and percentages of the relevant statistical question using the data stored in Table 170 and based upon this calculation, the system selects the most relevant questions from the statistical question field 171d based upon the facts of the lawsuit. A programmer may preprogram the questions within the survey database 131 or the questions may be entered dynamically during the jury selection process. The survey information collection system 133 enables a programmer to enter text of the questions manually, the text of the question may be entered through a voice-activation feature or the text of the question may be selected from a preformatted pull-down menu. The questions may be stored in the survey database 131 so that the questions may be reused and compiled to form a cumulative database of questions.

The question response field 171e stores the response received from a potential juror. If the potential juror's response contradicts or modifies the information previously stored within the survey database 131, the previously stored information may be overwritten. For example, if the previously stored information entered into the demographic field indicates that the potential juror is a married 45-year-old male, however, the potential juror when asked his age and marital status indicates that he is a single 40-year-old male. The information stored in the question response field 171d may be used to automatically and dynamically modify and update other fields such as the demographic field within Table 170. If there is neither a contradiction nor a need to further modify any information previously stored within Table 170, then, no modifications are made by the survey information collection system 133. The information stored in the question response field 171e is then compared with the statistical responses associated with the statistical question field 171d. Based upon this comparison, the survey information collection system 133 determines for each potential juror stored in the potential juror field 171f whether the potential juror shows a bias towards either the defense or the plaintiff. For each entry in the potential juror field 171f, a score or percentage is assigned and stored in the statistical score field 171g to indicate whether the potential jurors shows a basis towards either the defendant or the plaintiff based upon the potential juror's responses.

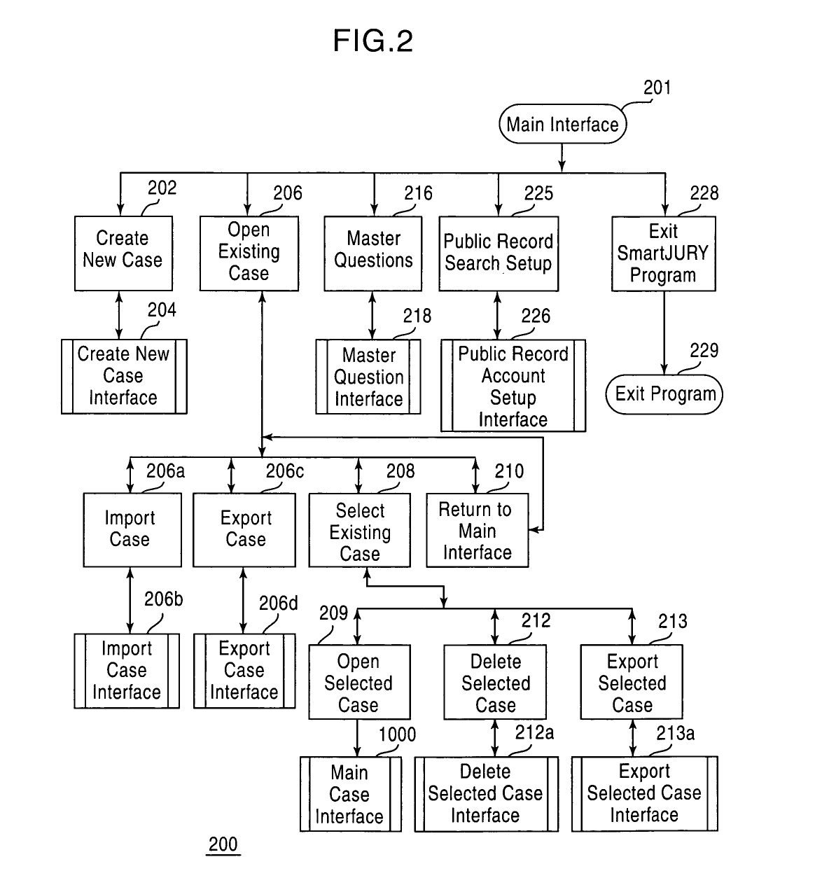

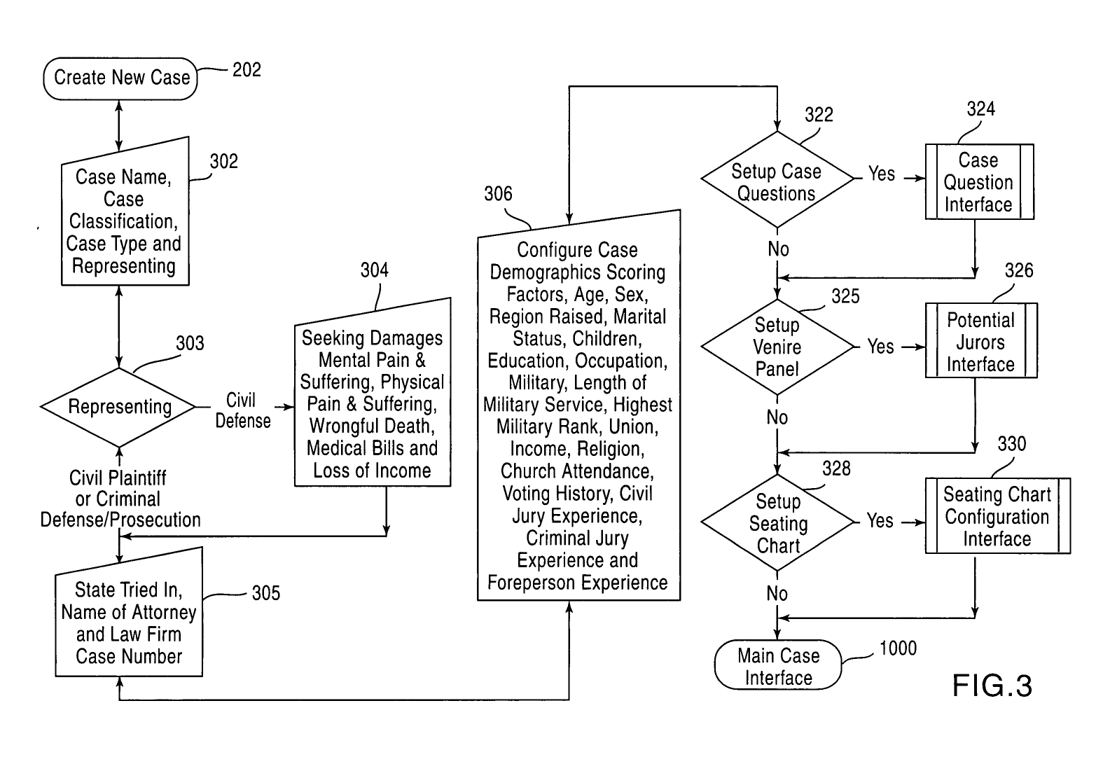

FIG. 2 is a block diagram of a structural overview of a jury selection management system 200 which may be employed according to an embodiment of the invention. Jury selection management system 200 may dynamically monitor the questions presented to members of a juror pool and record the responses provided by each member of the juror pool. Based upon the potential jurors' responses, the jury selection management system 200 may objectively and dynamically select the jury panel. In a courtroom, a judge presiding over a jury selection process may conduct the jury selection process in a fast-paced, arbitrary and capricious manner. Thus, an attorney who is conducting the “voir dire”, i.e., the jury selection process, may receive an enormous amount of information regarding each potential juror within a relatively short period of time. Nevertheless, each party must be able to assimilate and process this information and make a fairly quick decision as to the members of the juror panel whom would most likely best serve each party's interest.

For example, at the beginning of the jury selection process, the judge may invite the potential jurors into the courtroom and arbitrarily assign the seating order of the potential jurors. The judge may instruct, “On the first row, we will position ten potential jurors, on the second row, there will be eight potential jurors, on the third row, there will be eight potential jurors and on the fourth row there will be nine potential jurors.” The judge may then state, “We will begin numbering the potential jurors starting in the first row from left to right.” Typically, the judge will then instruct the attorneys to create a seating chart and numbering system according to the assigned seating arrangement. The attorneys will immediately construct a seating chart manually based upon the judge's assigned seating arrangement. Since each judge may have a different format or procedure for establishing the seating arrangement, it is oftentimes difficult for an attorney to construct a chart in advance of the jury selection process.

Although an attorney may receive, in advance from the court, a list which may name, for example, 300 potential jurors before the jury selection process begins, the attorney will not ultimately know who has been selected from the list to appear in court as a member of the juror pool until the judge begins to introduce the potential jurors. Thus, each party must be prepared to react immediately to the judge's introduction of the potential jurors. At the beginning of the introduction of the potential jurors, the judge may sometimes provide each party with a legal size piece of paper, which illustrates several small boxes that are meant to be representative of the potential jurors as seated in the venire seating. As soon as the jury selection process begins, the representatives for each party may attempt to record the events regarding each potential juror within the small boxes. However, since the juror pool may include forty or sixty potential jurors, the small boxes printed on the legal-sized paper, oftentimes, may not provide a sufficient amount of space to record each potential juror's information and to document the courtroom events. As the fast pace of the jury selection process proceeds, most of the time, the attorneys will end up with a legal-sized paper containing incomprehensible notes and shorthand notations, such as circles, arrows and scribbled text, drawn all over the chart. Each party must quickly analyze the composition of the juror pool, assesses each potential juror's background, if such information is available, and immediately formulate a strategy that would best serve each party's interest. Then, the judge may announce all of a sudden, “Let's select the jurors.” As each party may attempt to rely upon their confusing shorthand notation to select the jurors, a party may allow someone who should have been omitted or stricken to be inadvertently selected for the jury. Obviously, having to perform such tasks simultaneously can be an overwhelming and daunting task for both parties of the case; especially given the fact that the selection of the jury is the most critical aspect of a trial since the members of the jury will ultimately decide a defendant's guilt or innocence.

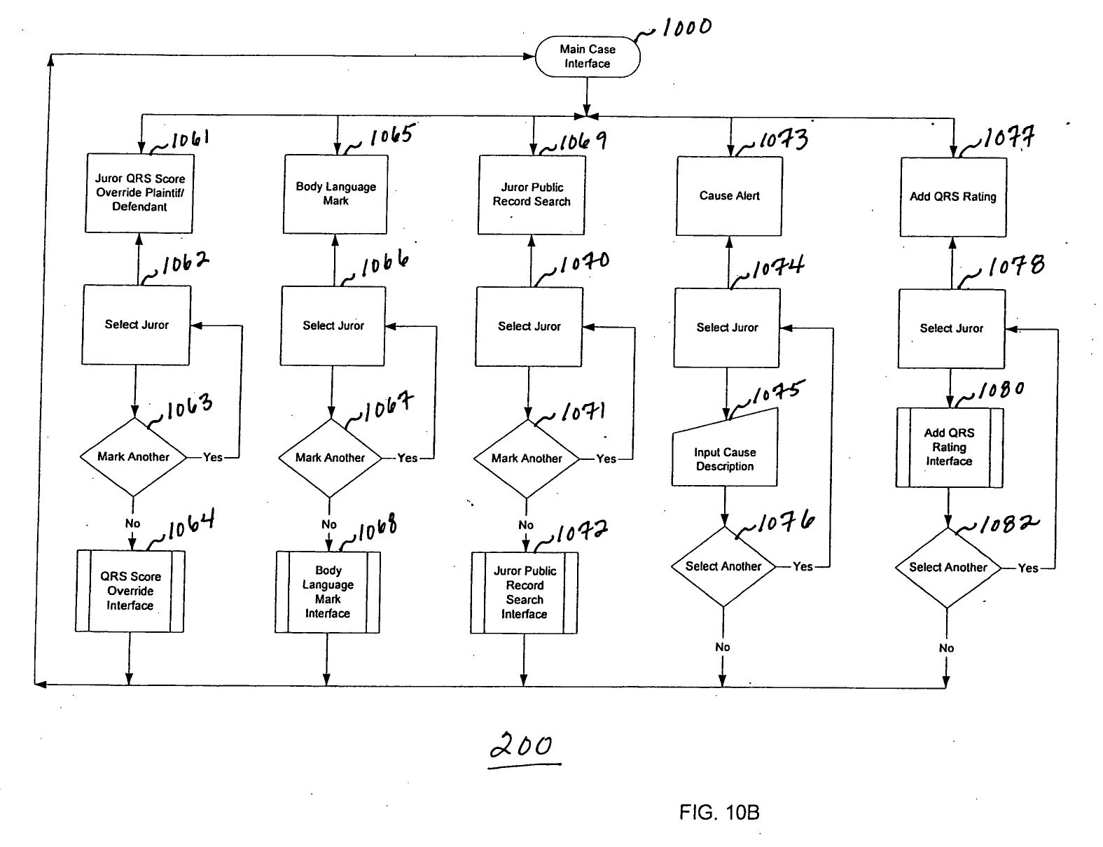

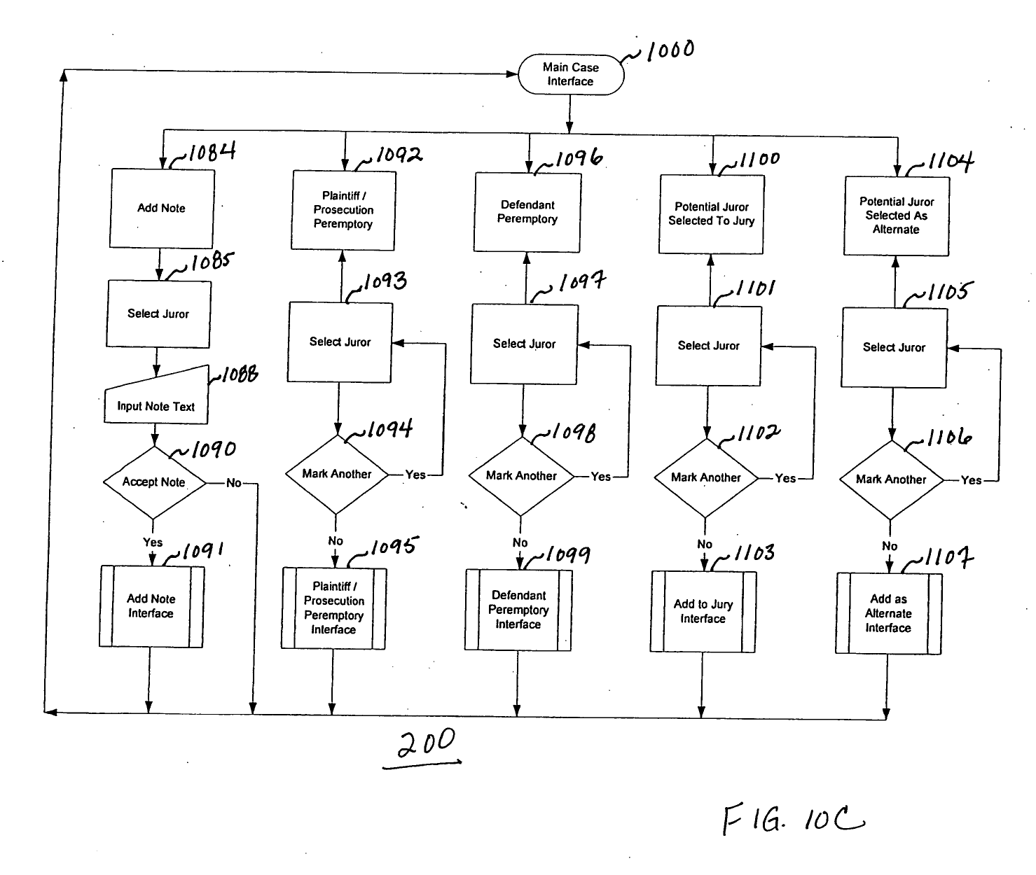

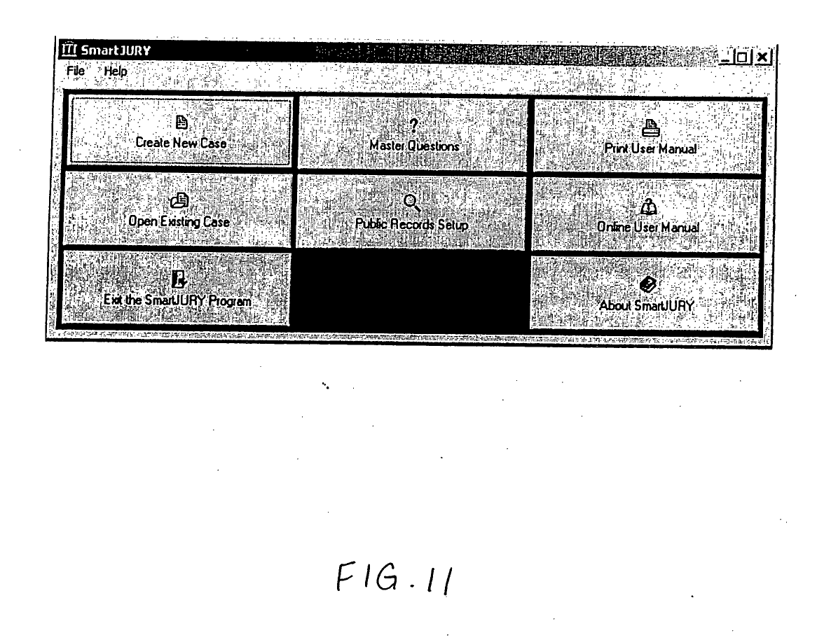

As shown in FIGS. 10A-10C, the jury selection management system 200, according to an embodiment of the invention, may enable a user to record the events electronically as they occur within the courtroom, provide a computer generated printout and record of the events, and perform a statistical analysis on the recorded events to aid in the selection of the jurors. The jury selection management system 200 can also provide computerized charts and graphs indicating the juror's score and response to each question or a grouping of questions. The jury selection management system 200 may also automatically and dynamically rate the potential jurors as the events occur within the courtroom. Thus, the jury selection management system 200 provides a concise and orderly method of monitoring, tracking and recording courtroom events.

The jury selection management system 200, according to an embodiment of the invention, may be capable of automatically constructing a seating chart as the judge directs the potential jurors to their seating assignment. In preparation for the trial, the invention may provide a simulation or a replica of a courtroom's jury box. The jury selection management system 200 may be pre-programmed by a programmer or user to include configurations of a particular courtroom's jury box or any other physical aspect of a courtroom's layout. Alternatively, the invention may be programmed to construct a standard courtroom jury box and other physical aspect of a courtroom. Prior to the initiation of the jury selection process, a user of the jury selection management system 200 may select from a list of pre-programmed courtroom jury box configurations. If the jury box configuration for a particular courtroom has not been pre-programmed into the system, the user may select the standard courtroom jury configuration interface.

Thus, as the potential jurors enter the courtroom, the user of the jury selection management system 200 may dynamically assign the users to seats. For example, the user may enter the juror's seating assignment by touching a touch-sensitive screen, activating a cursor control device 106, such as a mouse, a trackball or cursor direction keys. The user may also use alphanumeric keys to input the seating arrangement. Thus, as the judge announces each potential juror's name and seating position, the user may automatically enter the potential juror's assigned seating. Alternatively and/or conjunctively, a photographic device, such as a digital camera, may be connected to the jury selection management system so that a photographic image of each user may be taken and automatically transferred into the jury selection management system 200. The photograph of each potential juror may be displayed on the display 112 within each potential juror's seating position. Thus, according to this embodiment, the invention may provide the user with a visual photograph, which may serve as a selectable representation, of the potential juror.

Entry of the assigned seat or any other courtroom event may also be entered remotely by a user of the jury selection management system 200 who is viewing the courtroom events via a remote connection, such as via a television or satellite communication. As the remote user enters the seating position, the juror's position may automatically appear on display 112 for other persons located inside and outside of the courtroom to view the courtroom events. Each party's jury management selection system 200 may be interactively connected to a court-operated device. A courtroom employee such as a judge or a clerk of the court may operate the court-operated device, and the court-operated device may be capable of assigning the jurors' seating. Thus, the seating assignments interface for each party's device may interactively communicate with the court-operated device so that when the court employee uses the court-operated device to assign a juror to a seat each party's seating chart may also be automatically updated on each party's computer device.

Once the seating arrangement has been established, the jury selection management system 200 may automatically assign a selectable representation to each potential juror based upon his or her respective seating arrangement, as shown, for example, in FIGS. 18A-18B. As the events occur within the courtroom during the jury selection process, the user can automatically select the appropriate representation assigned to each respective jury to enter each potential juror's information.

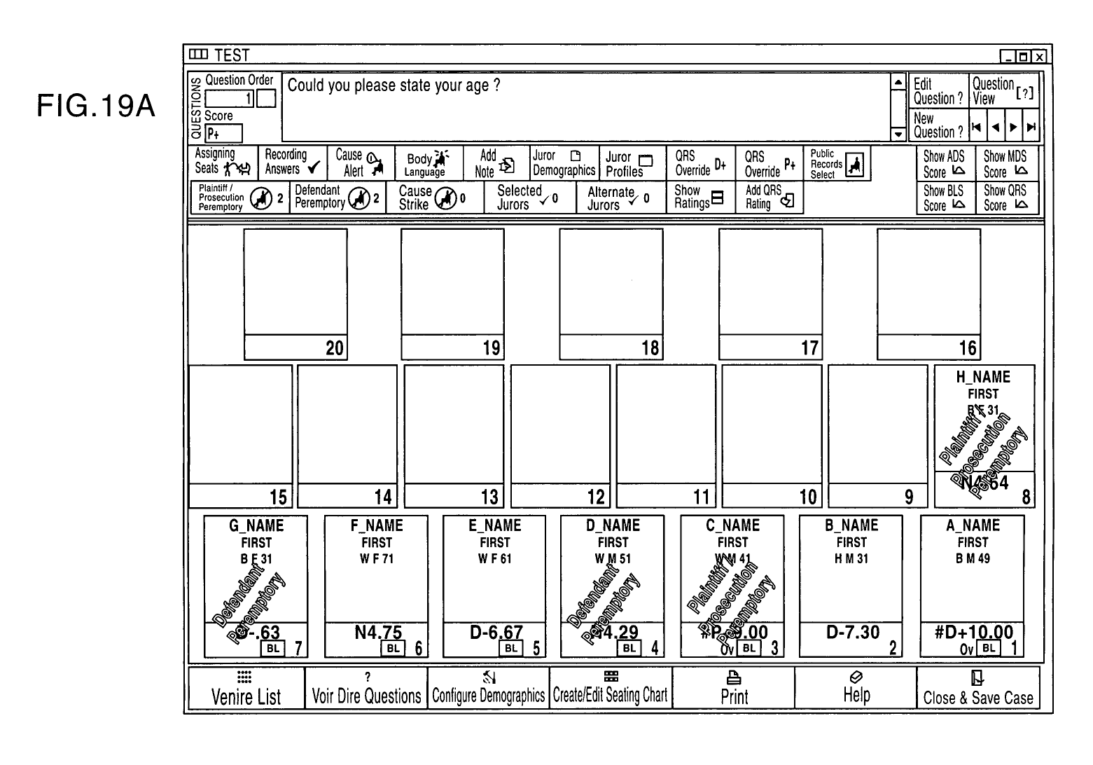

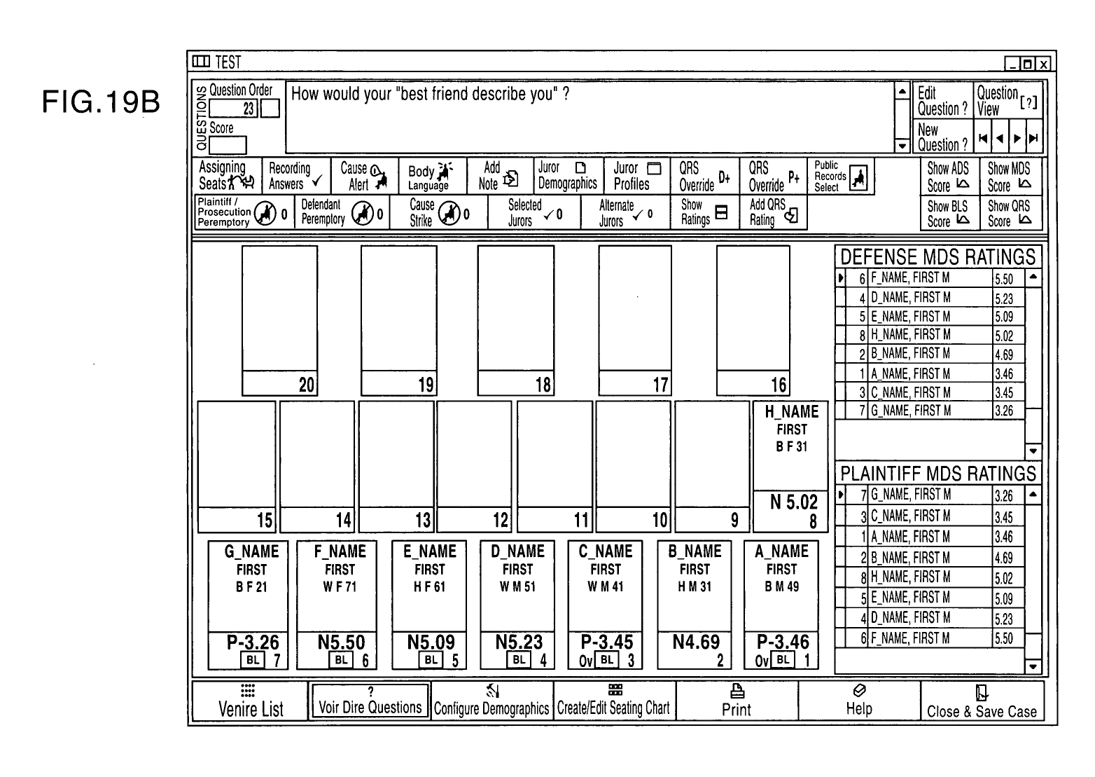

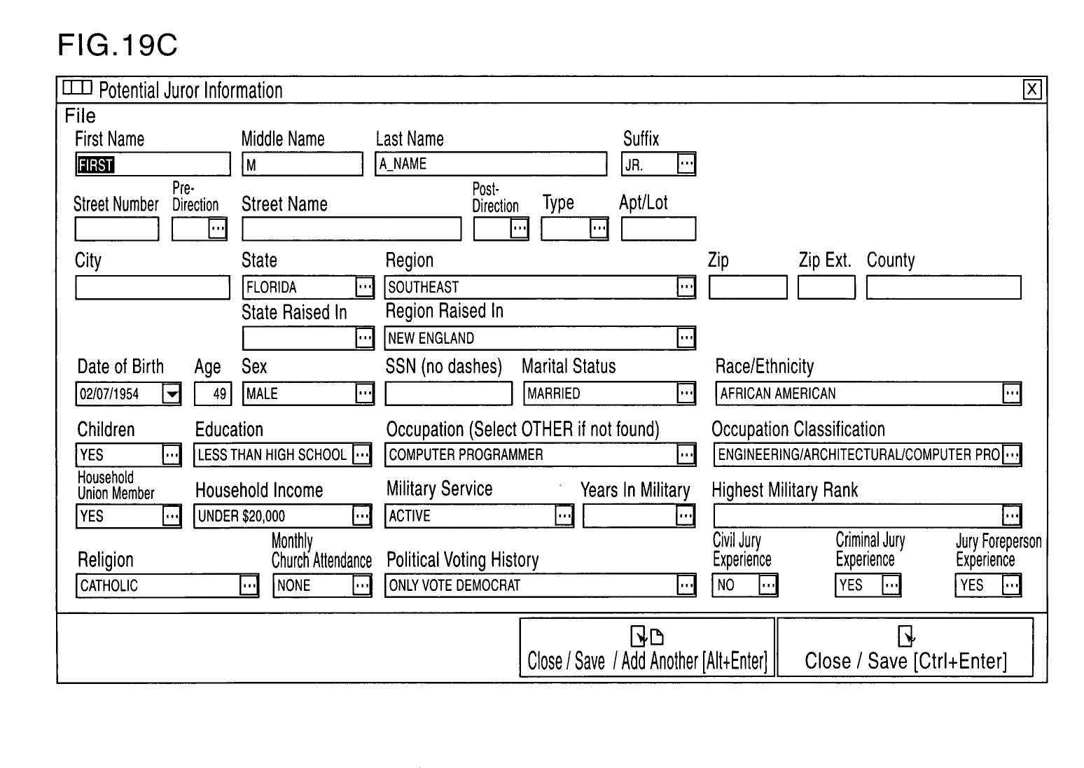

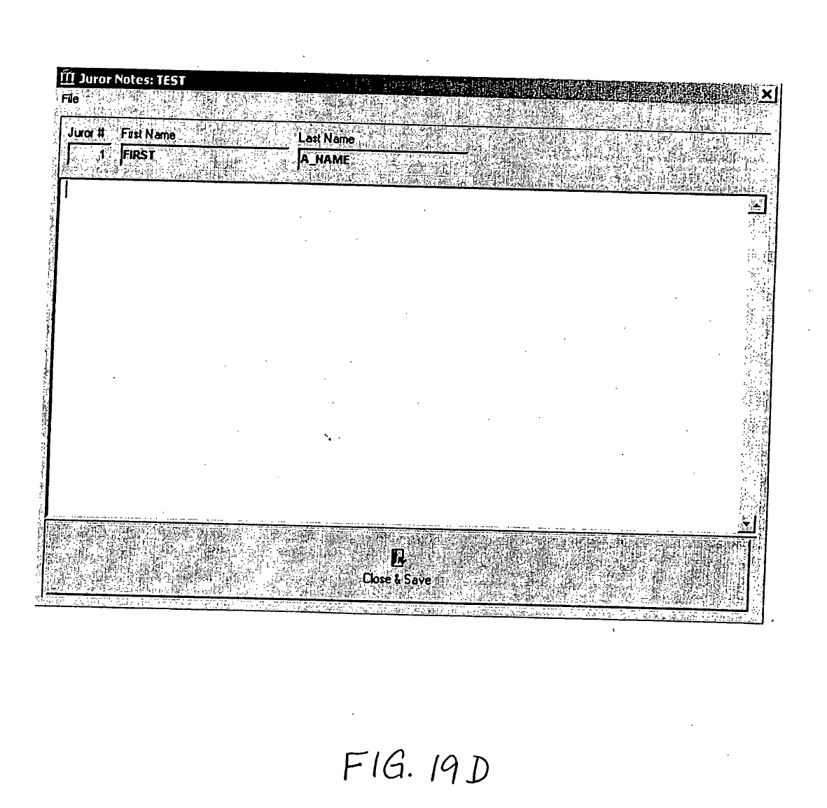

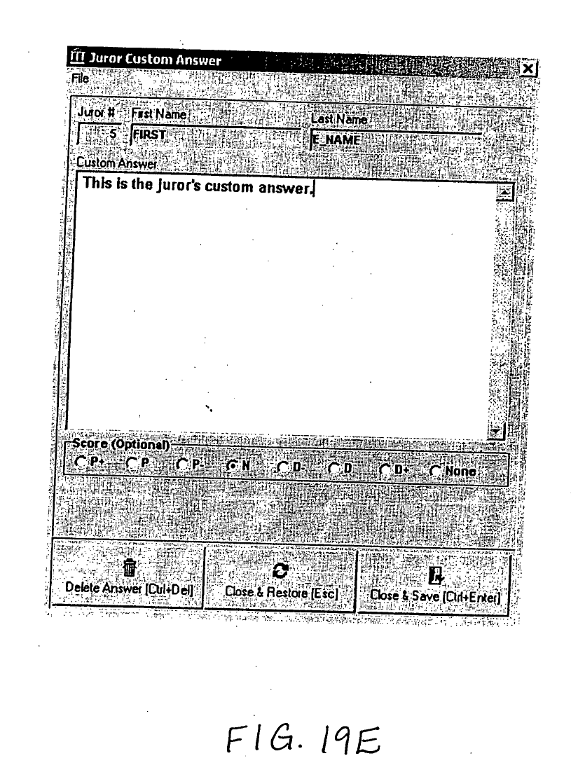

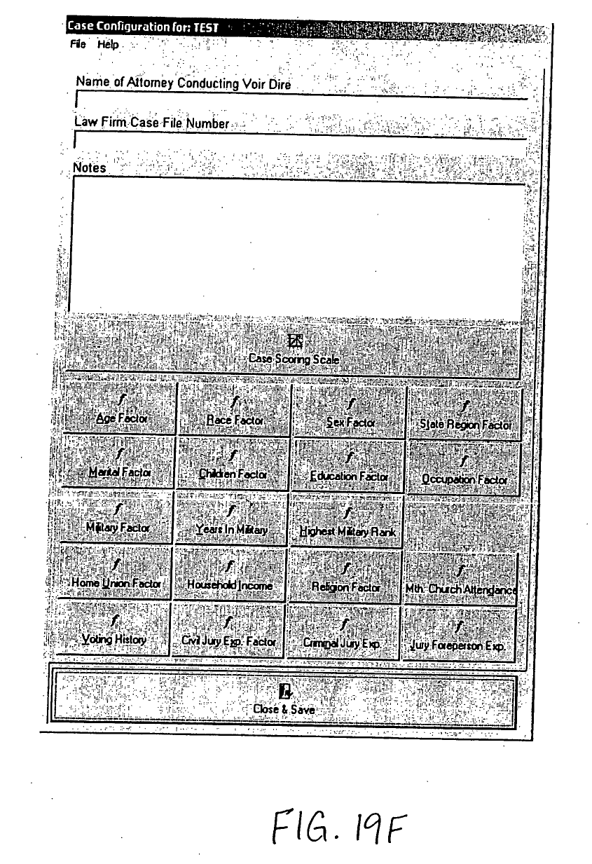

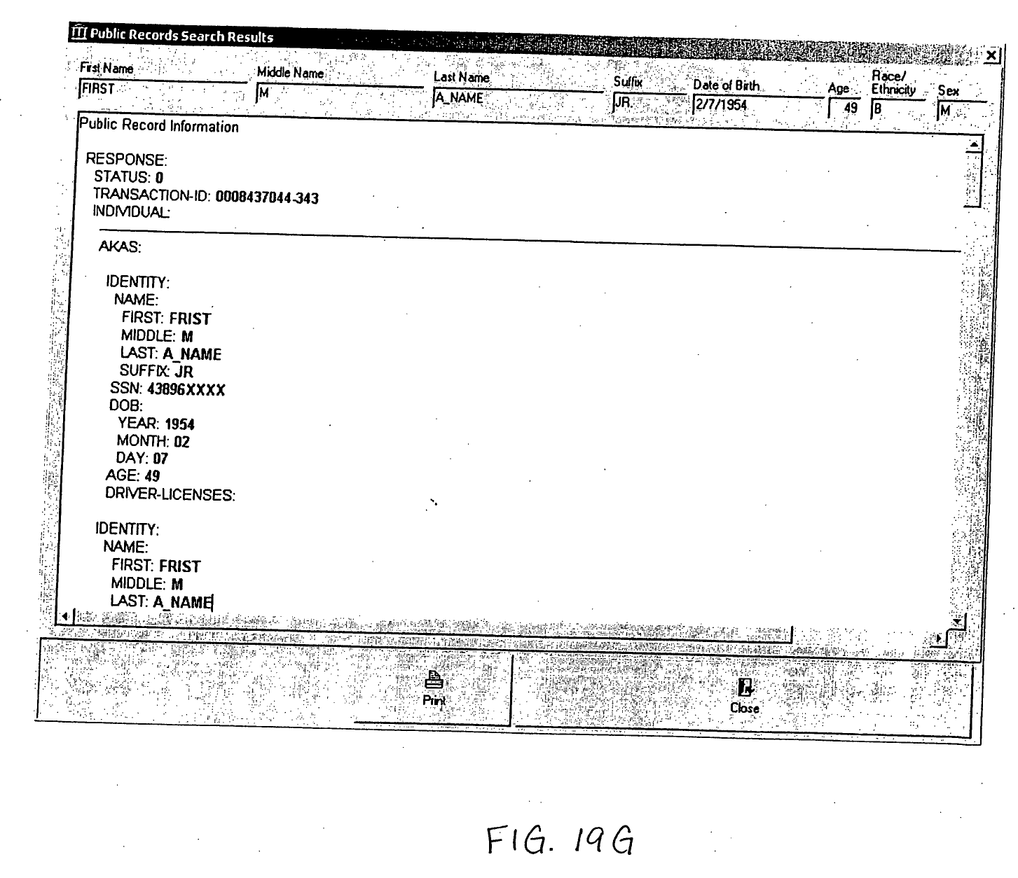

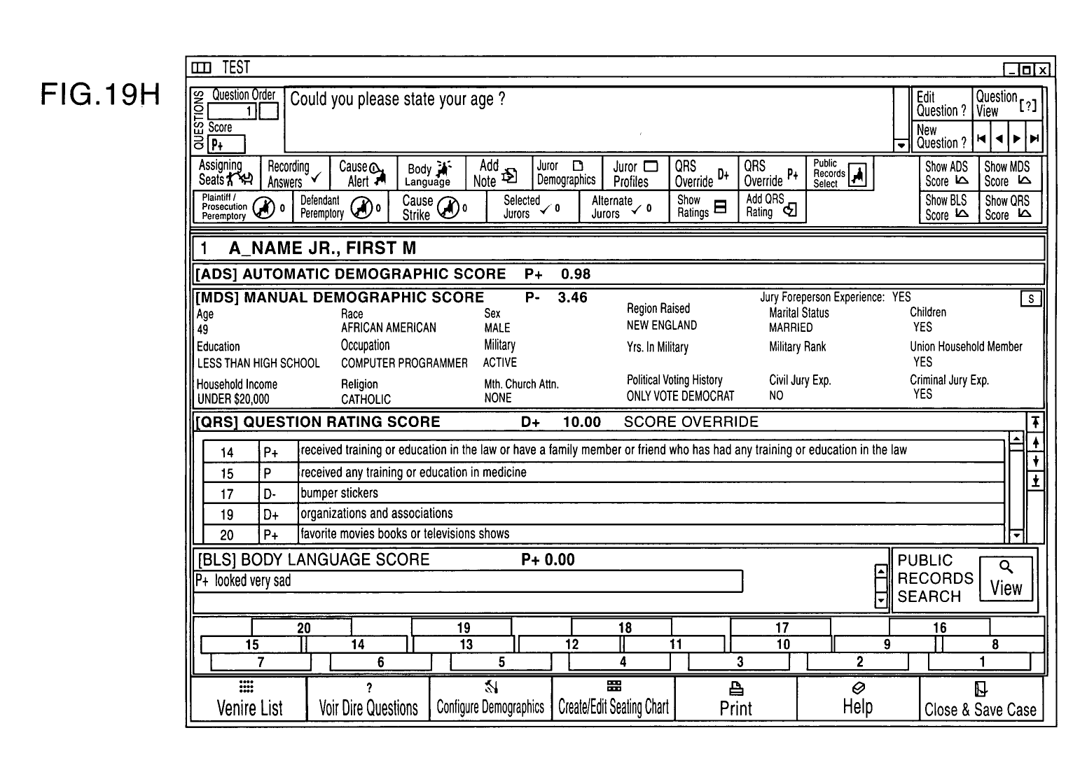

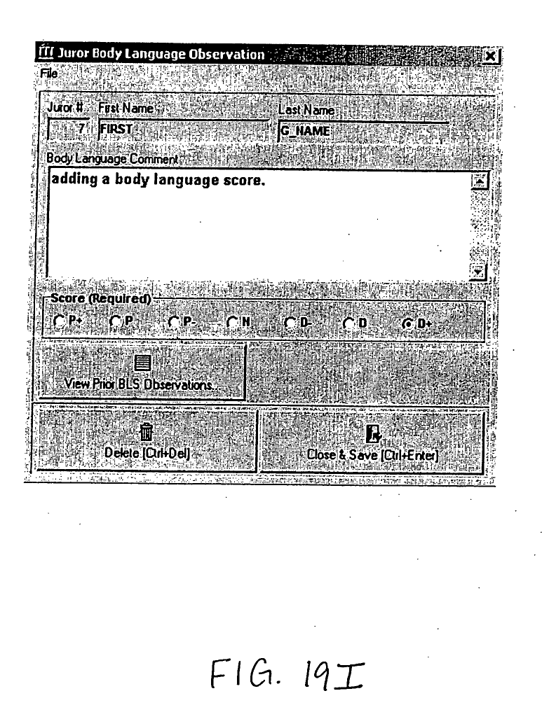

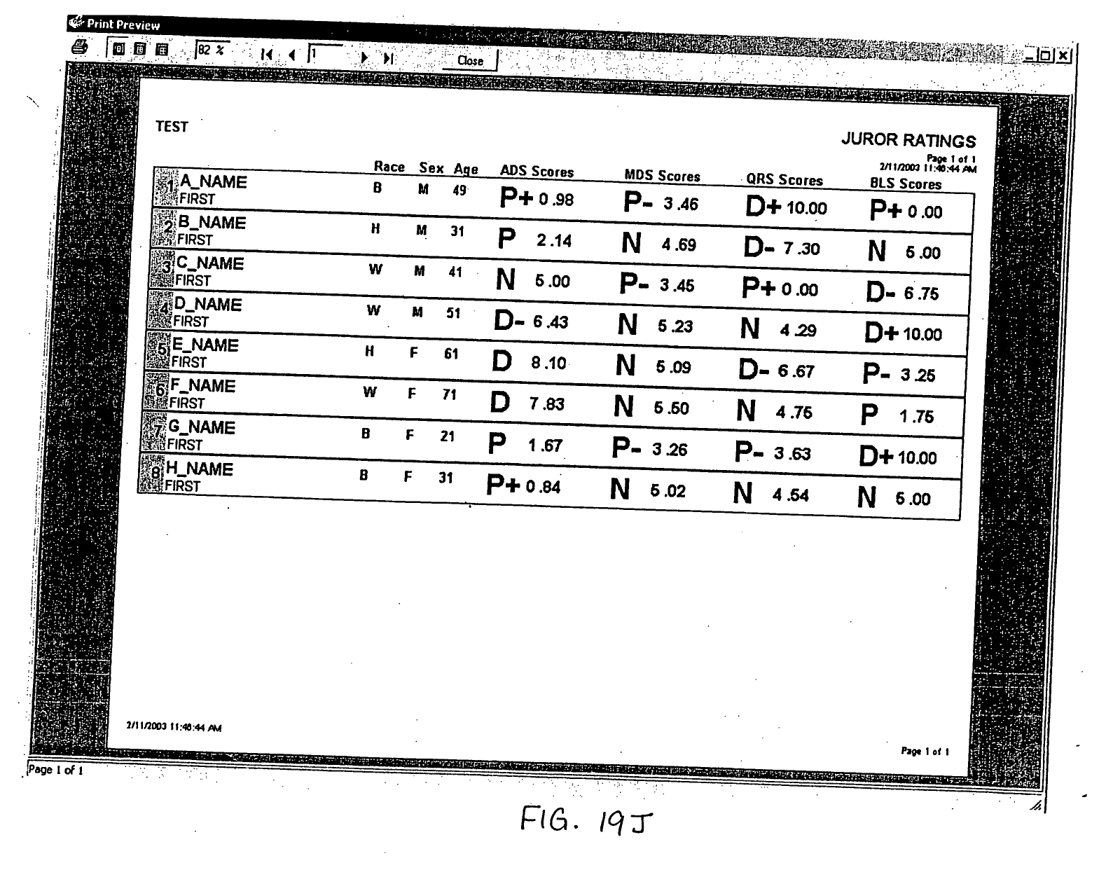

After the potential jurors have been seated and the judge instructs each party to begin questioning the jury panel, the jury selection management system 200 may enable the user to enter any comments or responses provided by each potential juror. If the defense attorney, for example, asks, “How many of you have previously served as a foreperson on a jury?” and if seven out of ten members on the panel indicate affirmatively, either by raising their hands or nodding their heads that they have served as a foreperson, the user can input each juror's response. The user may merely quickly activate the selectable representation that represents each potential juror and enter the user's response in the custom answer box shown in FIG. 19E.

The jury selection management system 200 may also be used to record verbal comments made by each juror. If a juror makes a statement that may be considered favorable, for instance, to the defendant's position, the user may input the favorable comment into the jury selection management system 200 so that this comment may be scored and considered by the jury selection management system 200 during its automatic calculation of the selection of the jurors. The jury selection management system 200 may be configured to assign, for example, a favorable score, an unfavorable score or a neutral score to comments made by the potential jurors. The user may initiate an add rating interface by activating an input dialog box in order to record the comments made by a potential juror and to select a rating to indicate that the comment was favorable for the plaintiff, neutral or favorable for the defendant. The add rating interface may also be configured to display any previous comments made by the potential juror. If more than one potential juror has provided the same response or comments, the add rating may also allow the user to copy the last juror's answer and score and quickly enter this information for one or more potential jurors.

The invention may also record and track several types of challenges that may be asserted by either party. The jury selection management system 200 may monitor and record the number of challenges asserted by both party and any reasons asserted to support such challenges. The jury selection management system 200 may also recalculate the number of challenges that remain available to each party. For example, the jury selection management system 200 may monitor and record challenges, such as challenges for cause, challenges to a jury array, a general challenge and a peremptory challenge. A challenge for cause is a request from a party to a judge that a certain prospective juror not be allowed to be a member of the jury because of specified causes or reasons. A challenge to a jury is an exception to the whole panel in which the jury is arrayed, based upon an account of partiality. This is a challenge to the form and manner in which the juror panel has been selected. This challenge goes to the illegality of drawing, selecting or impaneling the jury array. Another example of the type of challenge that the invention may monitor is a general challenge, which may be characterized as a species of challenges for cause, asserted against a particular juror, to the effect that the juror is disqualified from serving in any case. The decision as to which members of the juror panel a party should assert a challenge against may be analogous to playing a game of chess. Each party attempts to anticipate which members of the juror panel that the other side will disqualify. Thus, the jury selection management system 200 of the invention may assist each party in anticipating the other party's challenges and help each party to devise a strategy in order to select the members of the jury.

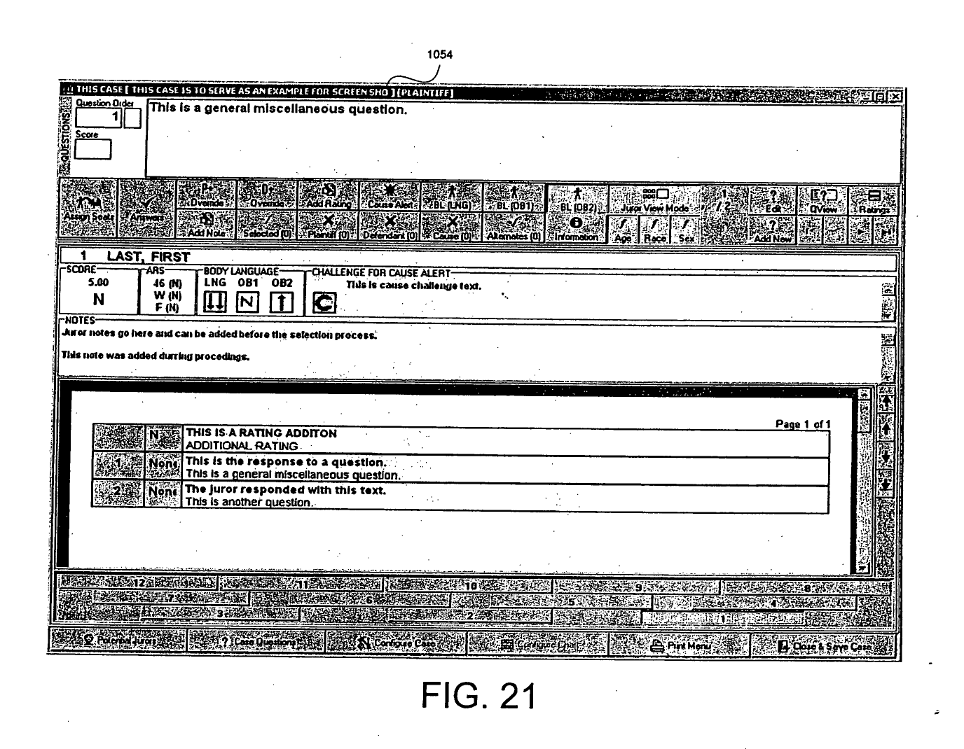

The jury selection management system 200 may also track comments that may be used later by either party to support a challenge for cause. For example, in a liability case against a cigarette manufacturer, if a potential juror states, “I do not think that I can be fair and objective in the present case because my sister died of lung cancer due to cigarette smoking.” The user may input this statement and select a representation to activate a symbol, such as a “C” to appear on display 112 to indicate that the juror has made a statement that can be used to support a challenge for cause, as shown in FIG. 21. As discussed above, a challenge for cause is a request from a party to a judge that a certain prospective juror not be allowed to be a member of the jury because of specified causes or reasons. Thus, in order to dismiss a potential juror based upon a challenge for cause, the challenge must be supported by case law. Thus, this feature, not only allows each party to immediately indicate that a potential juror has made a statement that can be used to support a challenge for cause but also provides case law to support such a statement. Once the challenge for cause statement has been made and entered into the system 200 by the user, the jury selection management system 200 may automatically search its databases to find case law to support this challenge for cause or allow the user to select state specific case law from a list provided by a programmer or built-in by the user.

The jury selection management system 200 may also be employed to track and record peremptory challenges. A peremptory challenge is a request from a party that a judge not allow a certain prospective juror to be a member of the jury. Although no reason or cause is needed to support a peremptory challenge, the number of peremptory challenges afforded to each party is set to a limited number either by statute or court rules. Thus, the jury selection management system 200 may be configured to record each peremptory strike asserted by each party and to inform the user of the number of remaining peremptory strikes that each party has available.

The jury selection management system 200 may also be configured so that demographic and personal characteristics for each juror such as a potential juror's race, sex, age and nationality may be entered and scored within the system as shown in FIGS. 14A-14C. The jury selection management system 200 may be pre-programmed before or during the jury selection to rate each personal characteristic. Therefore, the user may configure the jury selection management system 200 so that one or more personal characteristics may be assigned a score based upon the type of case. In preparing the case, if the defense decides, for example, that jurors who are 65 and over would be more favorable to the defendant, the defense attorney can have this characteristic flagged so that jurors who meet this characteristic will have their scores weighted favorably.

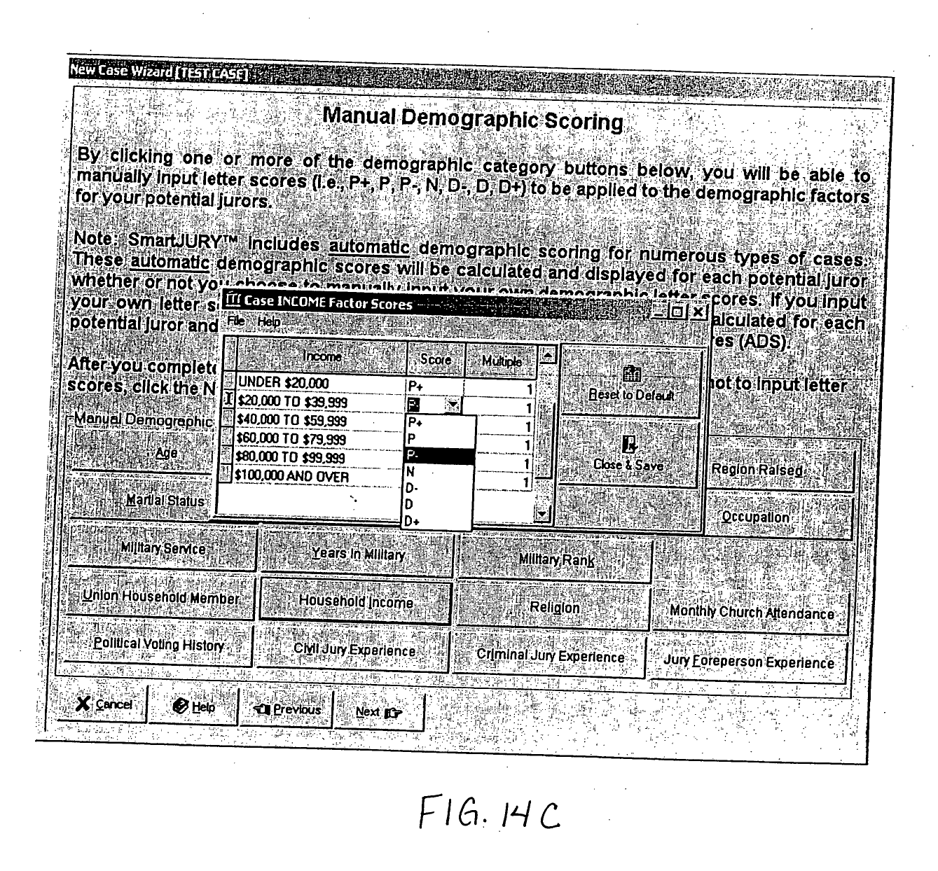

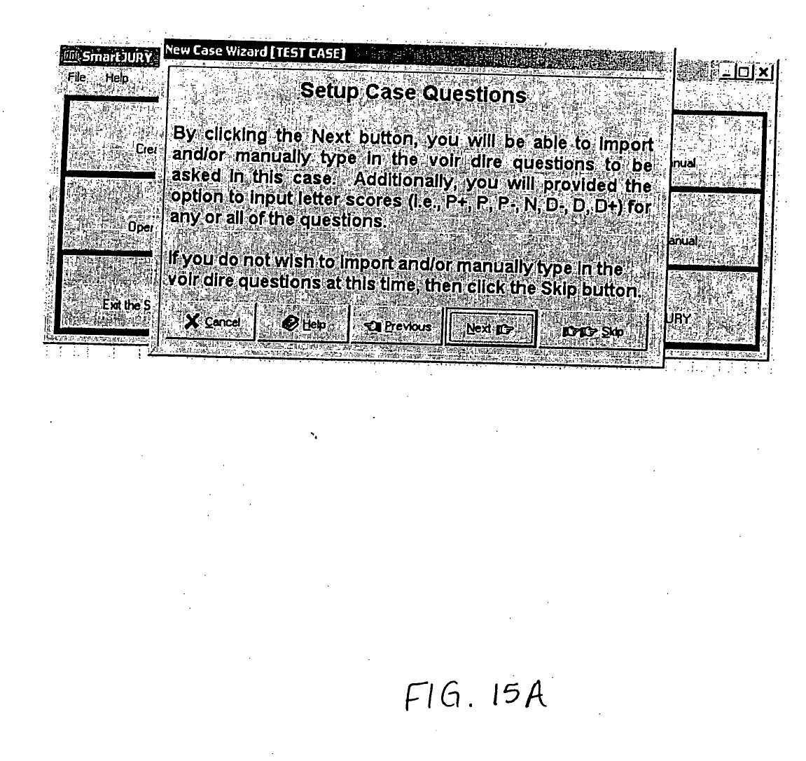

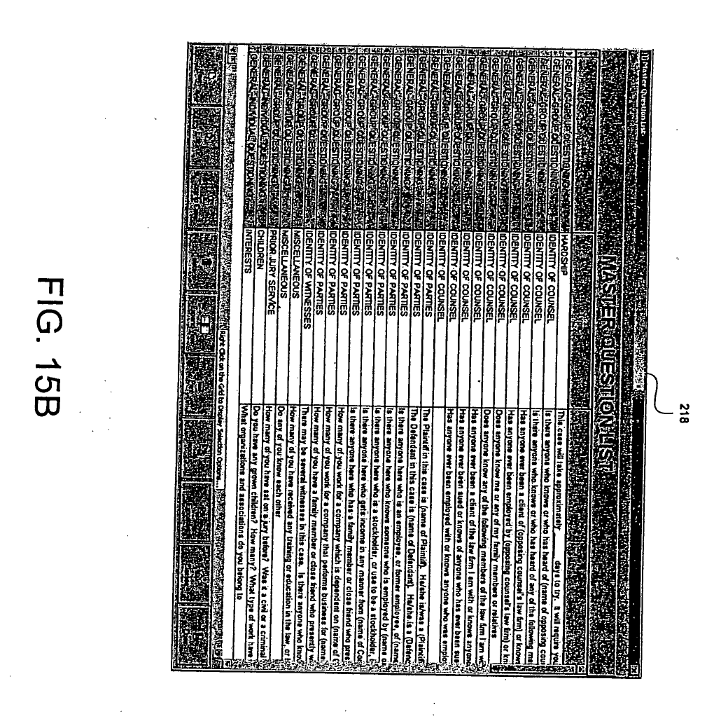

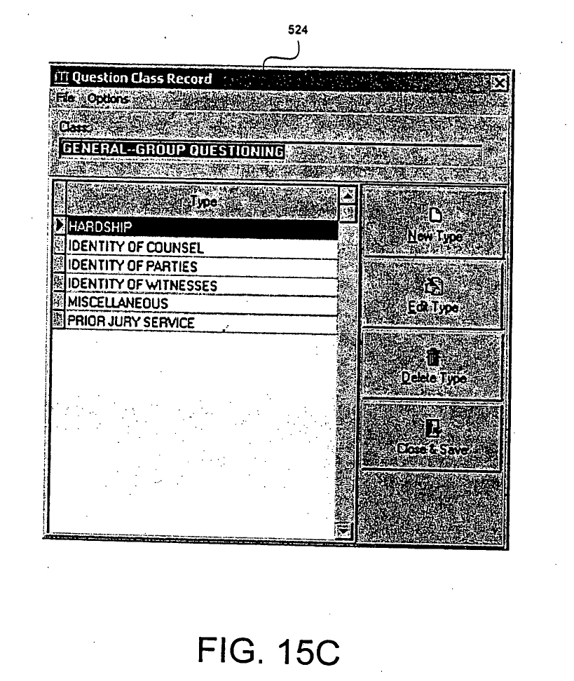

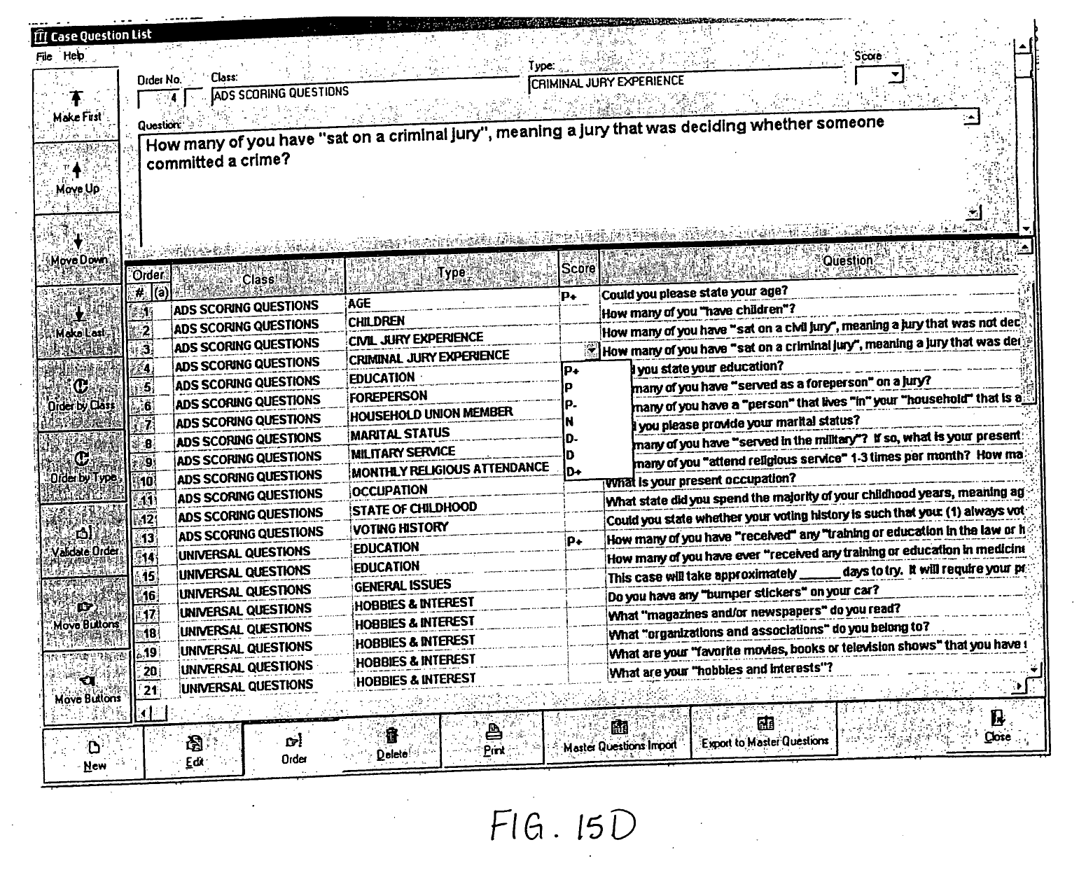

The jury selection management system 200 also may be configured to include one or more question databases, as depicted in FIGS. 15A-15E, which may assist the user in generating questions, that may be used by the attorneys during the voir dire. There may be a master question list (FIG. 15B), which may serve as a central database for the collection of all questions generated, and there may be a case question list (FIGS. 15D-15E), which may contain only the questions that have been selected by a user for a particular case. In preparing for a case, a party may use a case question interface 324 to interface with the master question database of the jury selection management system 200 to select and formulate the questions compiled within the case question list. A party may use its case question list when conducting the preliminary examination of the prospective jurors to determine the prospective jurors' qualifications and suitability to serve as jurors. A party may arrange the questions in the case question list based upon the class and type of questions (FIG. 15D) that he or she may wish to ask the jurors panel. Both the master question database and the case question interface 324 may contain questions, which have been previously drafted and stored in the jury selection management system 200. The master question database and the case question database may also assist a user to generate new questions, which may be added to the master question list and/or the case question list. Questions can also be added to both the master case list and the case question list dynamically during the jury selection process.

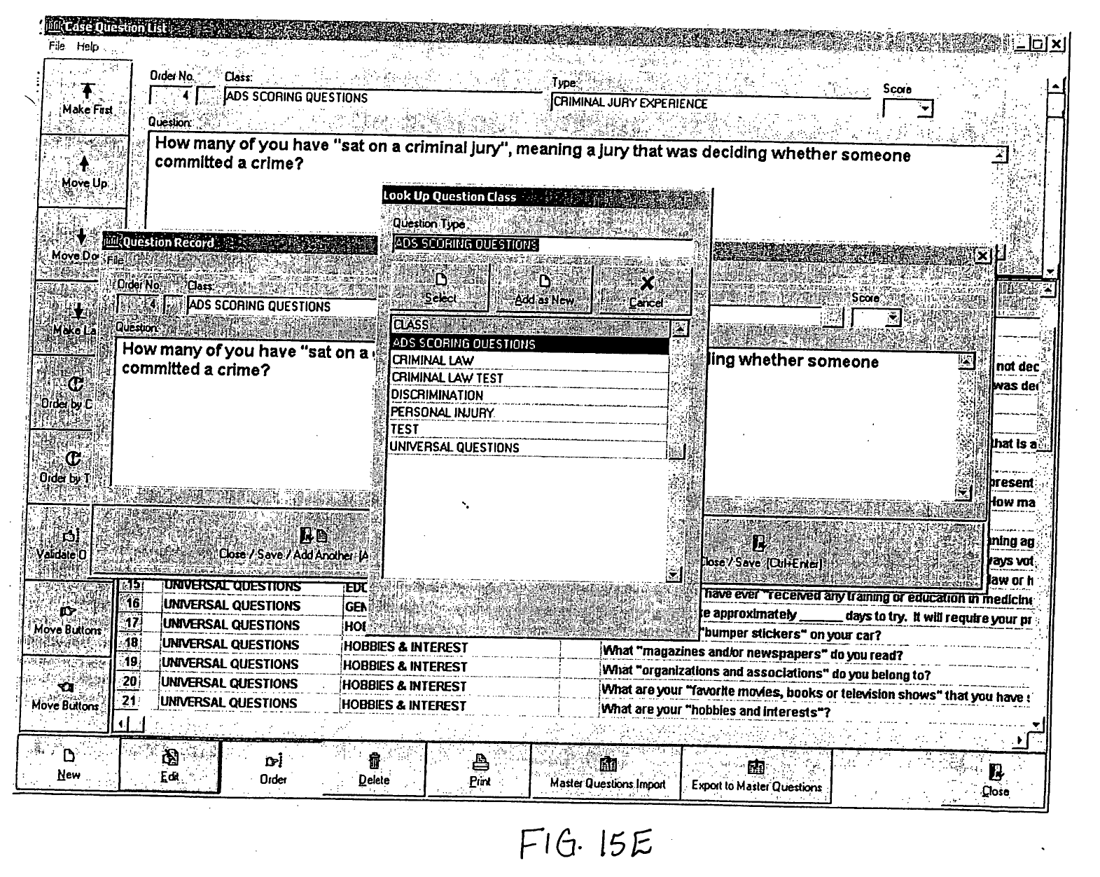

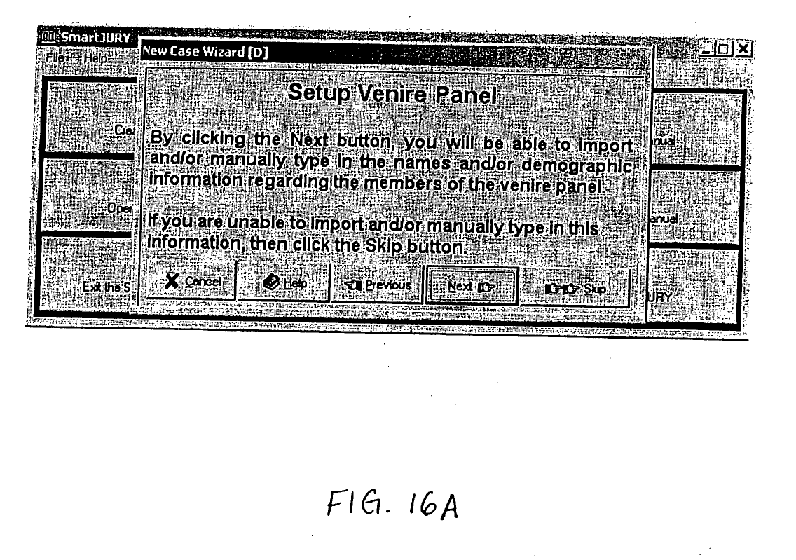

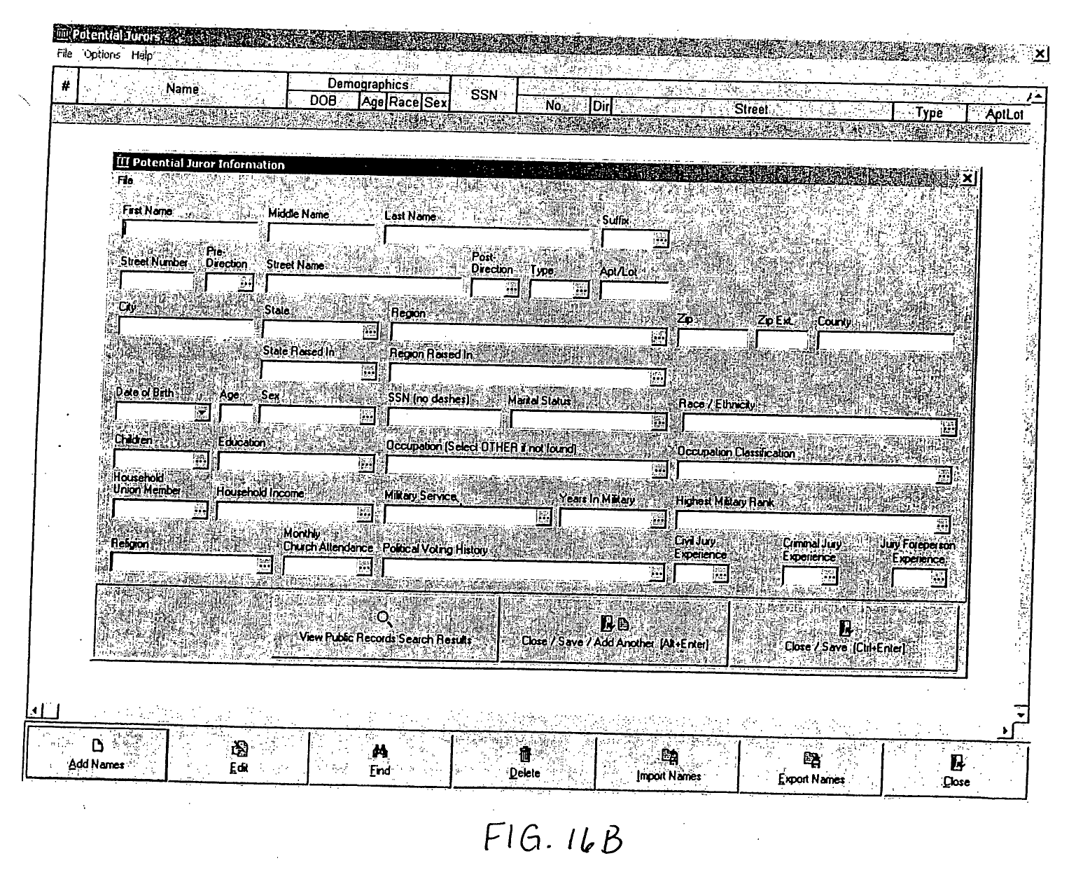

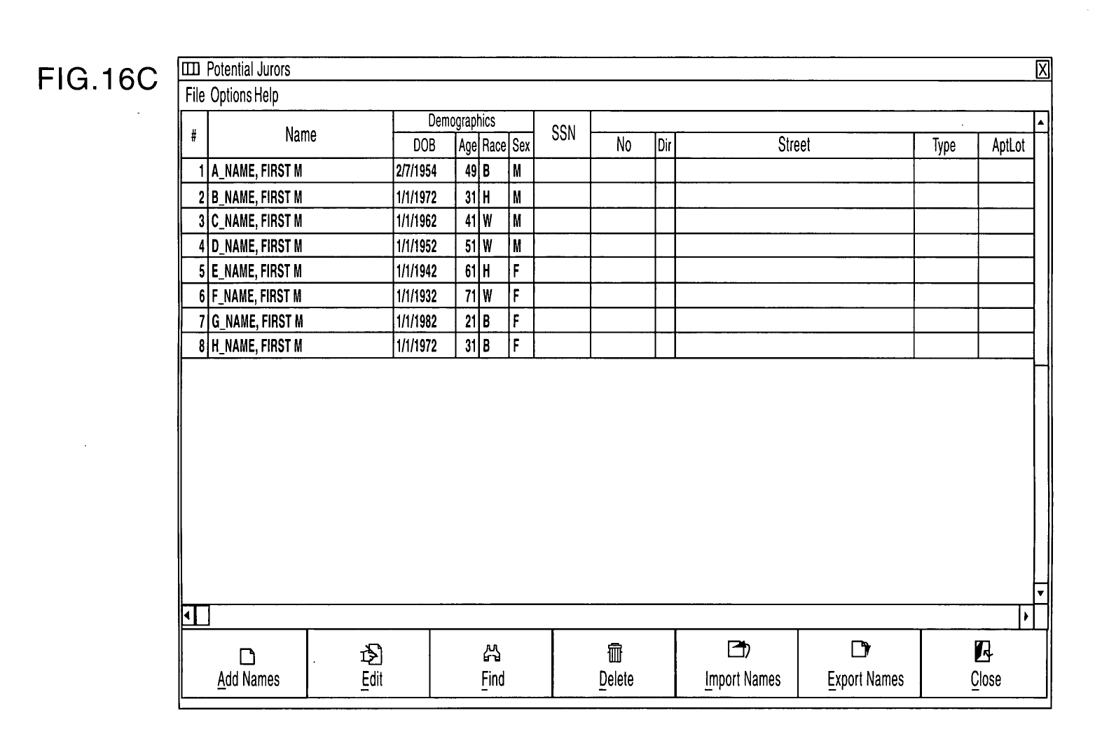

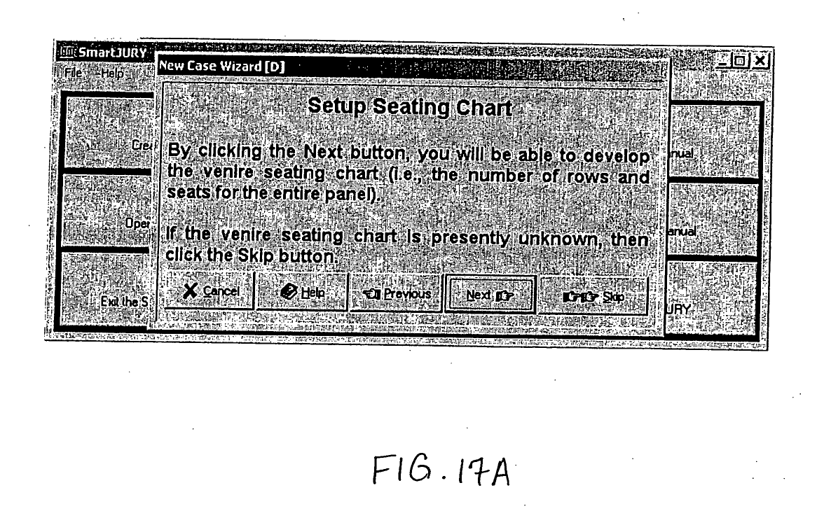

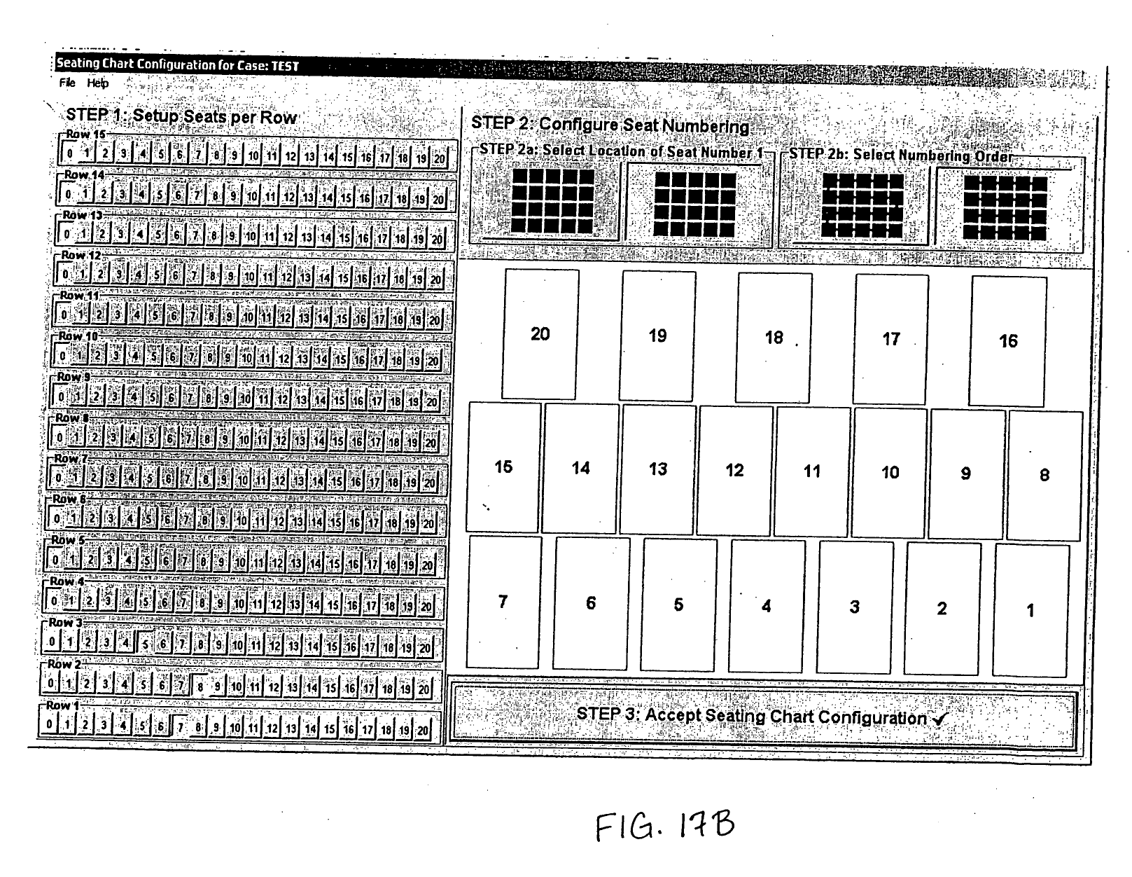

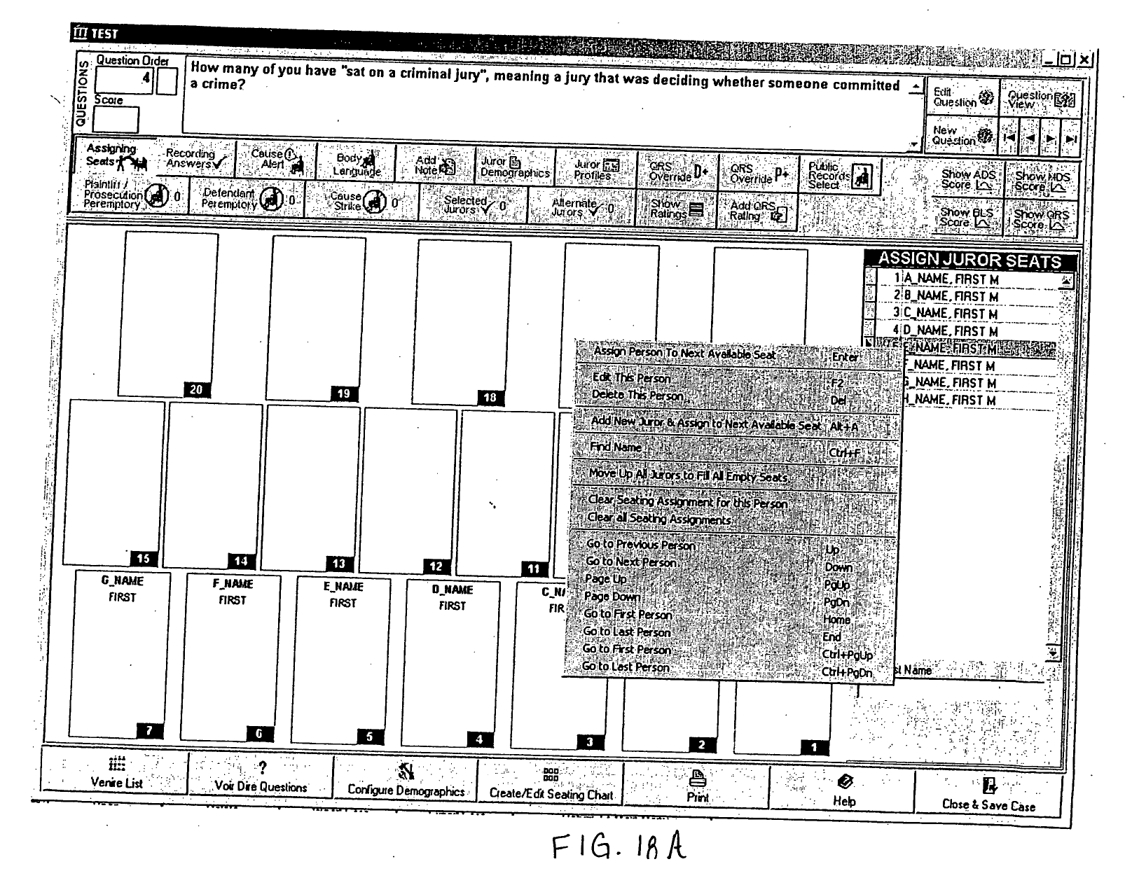

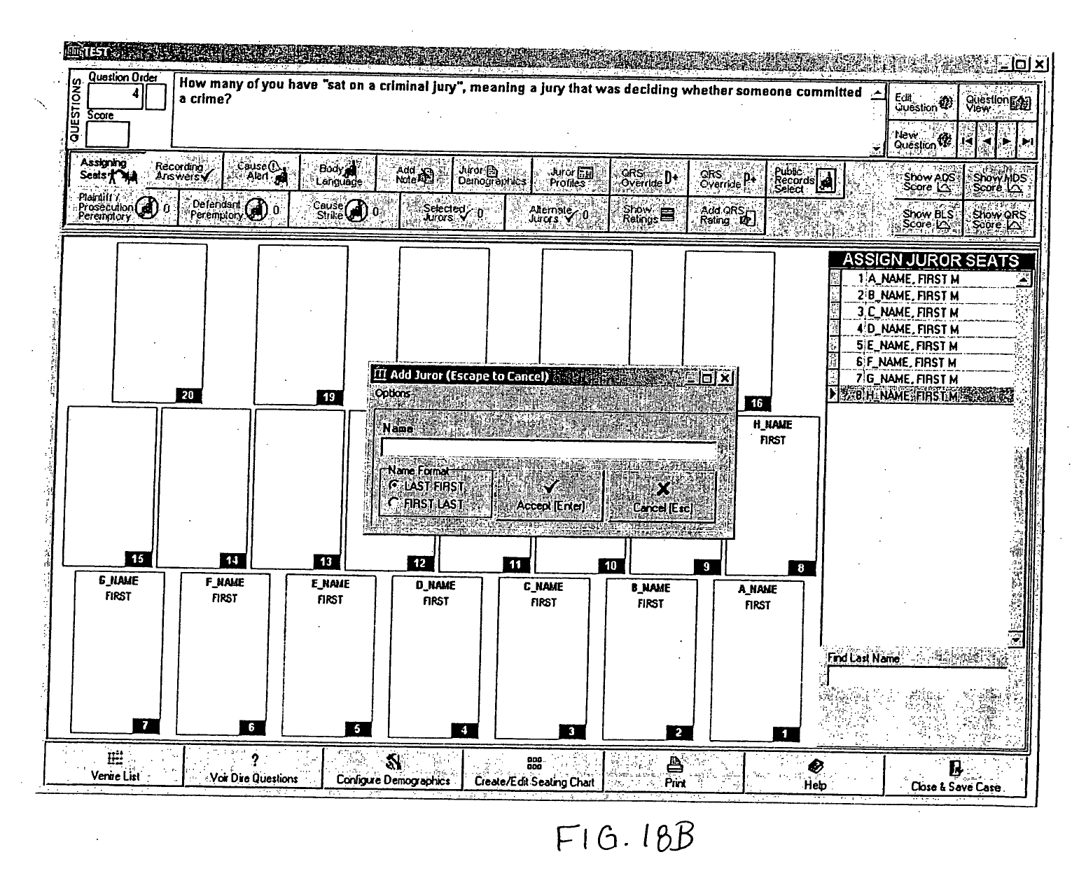

The jury selection management system 200 may further include a background database. Once a candidate's name has been added to the list of potential juror's, the background database may be used to discover background information about each potential juror. The background database may be used to discover information, such as each potential juror's driver's license, criminal record, ownership of property, mortgages, whether the potential juror has obtained any commercial licenses, such as a pilot's license, whether the potential juror has been trained and authorized to carry a concealed weapon, the type of magazines that the potential juror subscribes to, and whether the potential juror has served in the military. The user may configure the background database to perform a search for a specific type of background information. Alternatively, the background database may be programmed to perform a generic background search. The user may also use the jury selection management system 200 to run a real-time background check on a potential juror during the jury selection process. The jury selection management system 200 may automatically conduct the background check and instantaneously provide the user with a background report. The information retrieved during the background search may be inserted within the perspective juror's record and displayed on the display 112, as shown in FIG. 16B. The information retrieved within the background search may also be scored by the jury selection management system 200.

The jury selection management system 200 may also include a body language rating database as illustrated in FIG. 19H. The body language rating database may permit the user to enter any body movement that a juror may make or exhibit, which may be indicative as to how a juror may vote on the question of the defendant's guilt or innocence. For example, if a potential juror frowns or smiles in response to a question asked from an attorney, the user may manually enter this juror's body language. Alternatively, the user may activate a list or menu and select a selectable representation, which corresponds to the respective body language. The jury selection management system 200 may also be configured to score and rate each potential juror's body language. The body language recorded in FIG. 19H is that the potential juror “looked very sad.” Therefore, the user scored this body language with a P+ rating as being favorable to the plaintiff.

Whether a party represents the plaintiff, prosecution or defense in a legal case, in general, the jury selection management system 200 may create a seating chart and even shift the positions of the seats in the seating chart automatically. In order to assist a party in preparing his or her case, the jury selection management system 200 may allow a user to select from hundreds of jury questions stored in a central database or the user may add new questions to the system. The jury selection management system 200 may also allow a user to instantly and clearly record potential juror responses, demographic information, comments made by a potential juror and body language exhibited by the potential jurors. All data inputs that may be recorded and monitored by the system may be assigned a score. Another feature of the jury selection management system 200 that may be provided to a user is that the system may conveniently display all of the recorded information on a computer screen, for example, of a laptop computer in an easy-to-read chart. The system may also enable a user to print a copy of all of the recorded information in the system in several different formats such as computer-generated charts, listings or as a text printout. The system may also enable a user to flag potential strikes—both preemptory and for cause. The invention may even rank the potential jurors from the most to the least favorable and automatically update the rankings with each juror response.

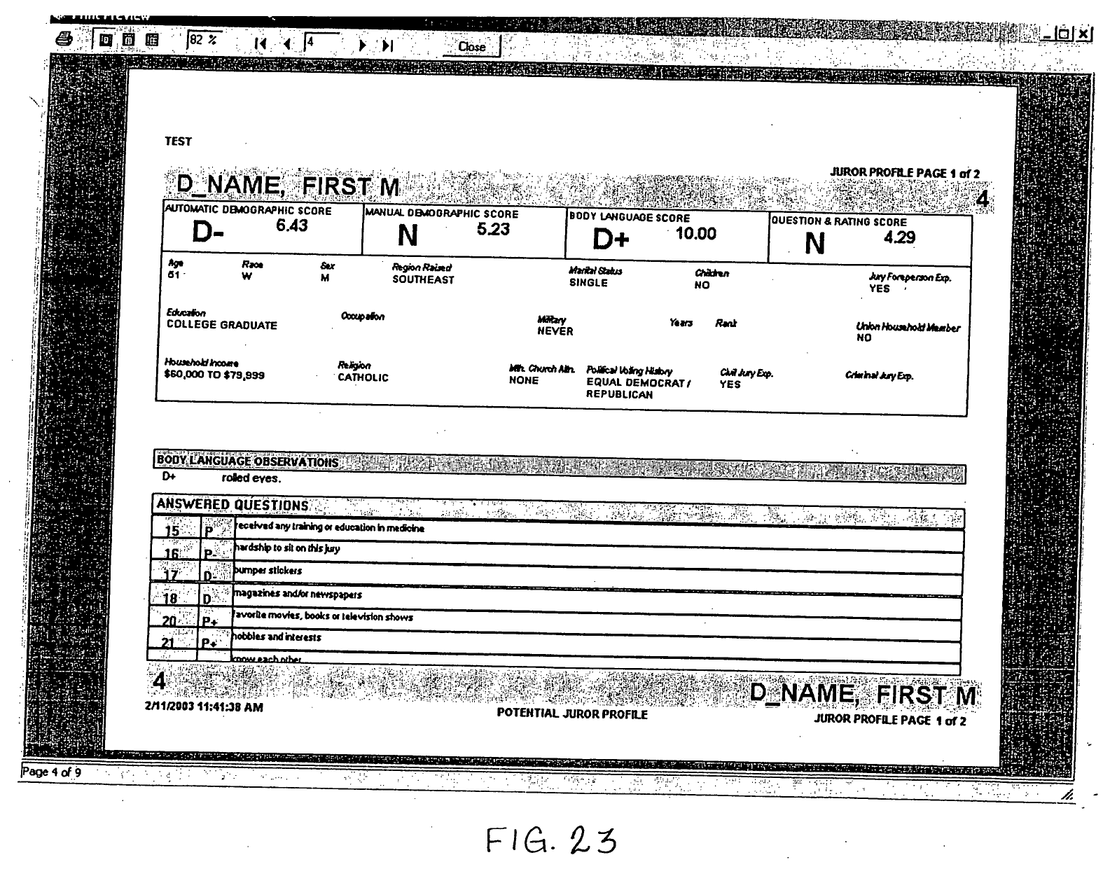

During the operation of the pre-selection preparation stage, the user may create a case record as illustrated in FIG. 1B in Step 132 and in FIG. 2. The jury selection management system 200 may be implemented according to the exemplary device as shown in FIGS. 2-23. FIG. 2 illustrates a system that may include components such as a main interface 201, a create new case menu 202, an open existing case menu 206, a master question menu 216, a public record search menu 225 and an exit program representation 228. In order for the user to set-up and format the jury selection management system 200 for each case, a start-up menu may be provided to the user by activating the main interface 201. Display screens corresponding to various selectable functions such as create a new case 202, open an existing case 206, establish a master question list 216, a public record search setup 225 and exit the jury selection management system 228 may be displayed when the appropriate functions are selected in the main interface 201, as shown in FIG. 11. Each of the selectable functions may be displayed as extensions to the main interface display, and further options provided by each selectable function can be revealed or hidden by activating toggle option buttons.

In the main interface 201, the create new case menu 202 may allow the user to create a file for a new case, and, when selected, may initiate a create new case interface 204 that enables the user to enter information regarding the new case.

The open existing case menu 206 may allow the user to open a previously created file and retrieve information regarding a case that has been previously established and stored in the jury selection management system 200. An import case 206a menu and an import case interface 206b may allow the user to import information regarding a case. An export case menu 206c and an export case interface 206d may permit the user to export information regarding a case. Upon activation of the open existing case menu 206 by the user, a select existing case interface 208 may be automatically initiated. The select existing case interface 208 may provide a listing of selectable previously created cases. If the user selects one of the previously created cases by activating an open selected case interface 209, a search of a main case interface 201 may be automatically initiated to retrieve all information stored in the jury selection management system 200 regarding the selected case. The system allows the user to return to the main interface 210. Other option menus provided in the main interface 201 under the existing case menu 206 may include a delete selected case menu 212, delete selected case interface 212a, export selected case 213, and export selected case interface 213a. The delete selected case interface 212a may allow the user to delete all or some of the information previously created and stored in the system regarding a specific case. The delete existing case menu 212 may also be used by the user to purge all previously created cases from the jury selection management system 200.

The master question menu 216 as shown in FIGS. 2 and 15B may allow the user to select questions from the question database, edit questions in the question database or add questions to the database. A master question interface 218 may be activated when the master question menu 216 is selected. The master question interface 218 may allow the user to select previously entered questions, to download questions from a website via an Internet connection, download questions from a server or host on a local network, import questions from existing text processing program data files, or to create new questions that may be stored in a case question list and used during the voir dire process for a specific case.

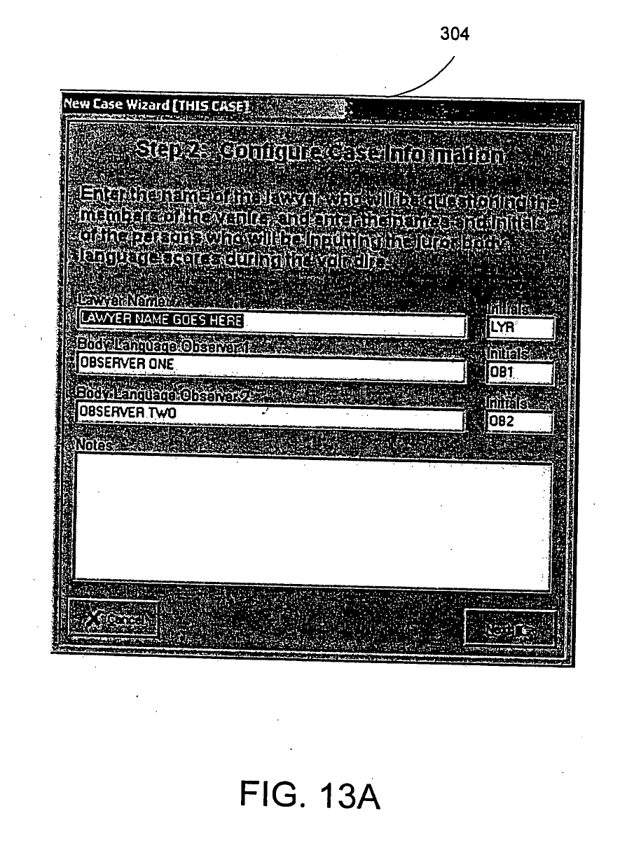

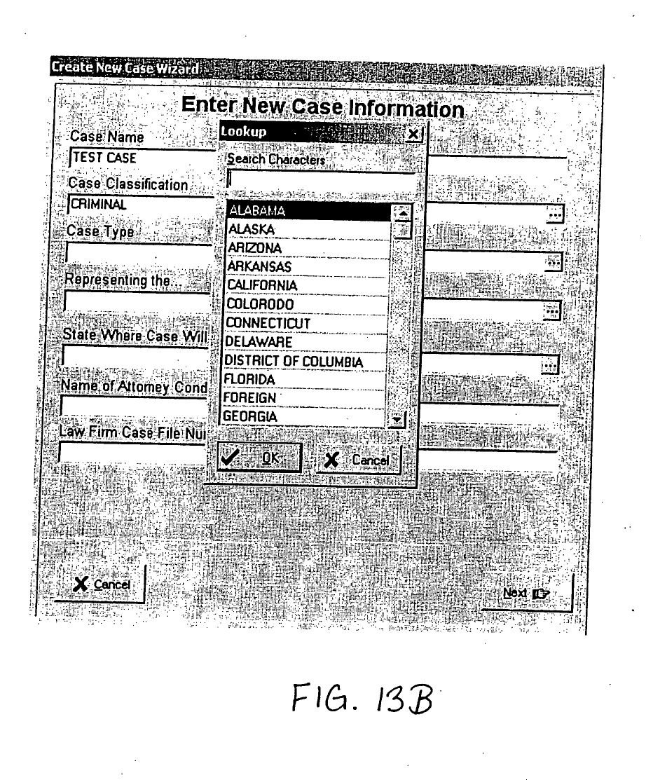

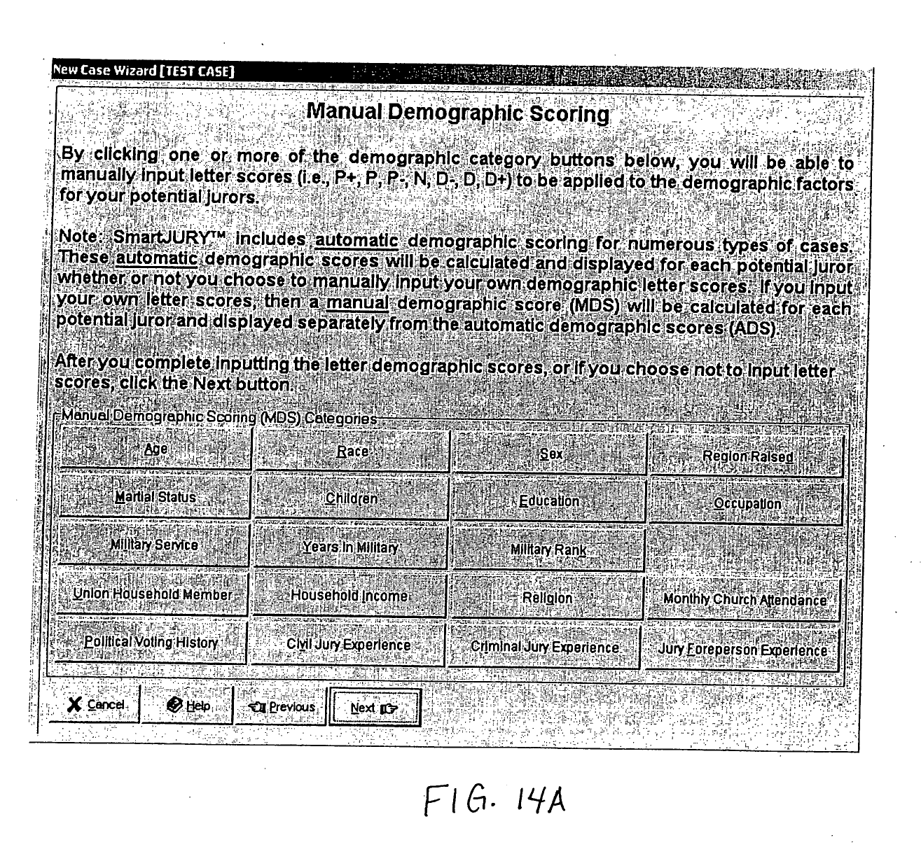

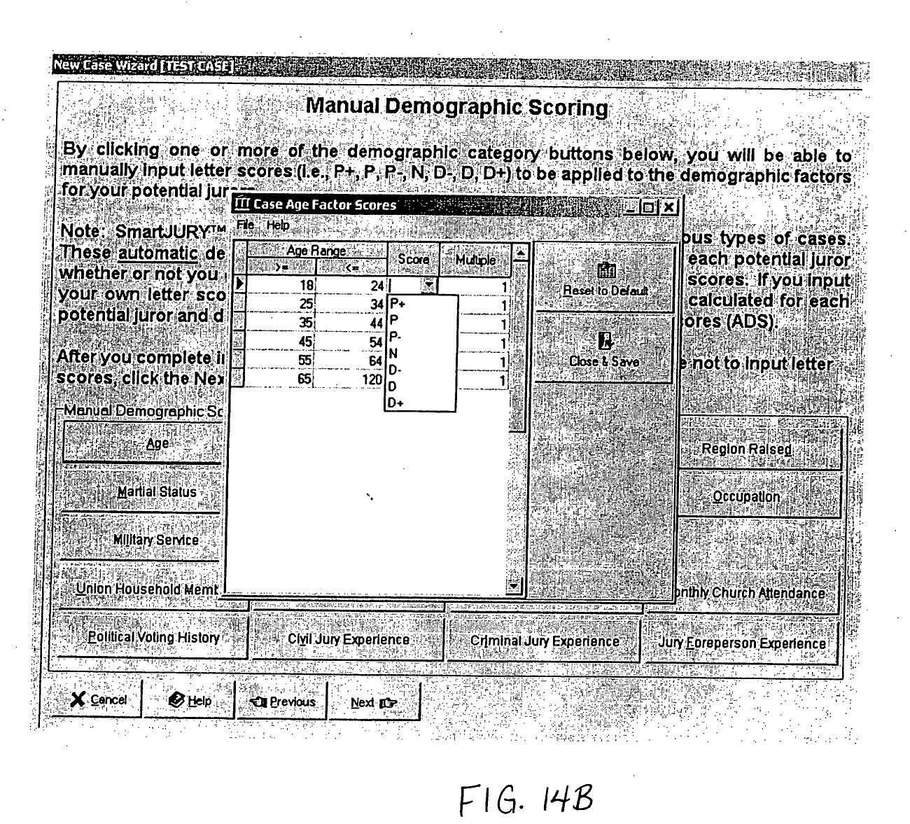

The jury selection management system may enable a user to store his or her personal preferences, such as the display screen's format. The user may establish the user's personal preferences, such as the law firm's name, the attorney's name, the state in which the attorney practices law, state or federal specific configuration options, any options global to the jury selection management system 200 and any other selectable representations as shown in FIGS. 13A-13B.

The public record search setup menu 225 may allow the user to conduct an electronic search of a database. The record search menu 225 may be used to search a database such as a public database or a secured database. A password, an encryption code or other security mechanisms may be used to access secured databases. For example, a record account setup interface 226, which may be configured as a pull-down menu from the record search menu 225, to enable the user to establish an account which may be used to monitor, record and collect fee information regarding the use of a secured database. The record search menu 225 may be used to access databases such as the background database. As discussed, the background database may be used to discover information, such as each potential juror's driver's license, criminal record, ownership of property, mortgages, etc. If prior to the jury selection process the parties receive from the court a list containing the names of potential jurors, the record search menu 225 may be used to perform background searches on the potential jurors. The information gathered on each potential juror may be saved and stored within the jury selection management system 200.

The exit program menu 228 and exit program interface 229 may permit the user to exit the jury selection management system 200.

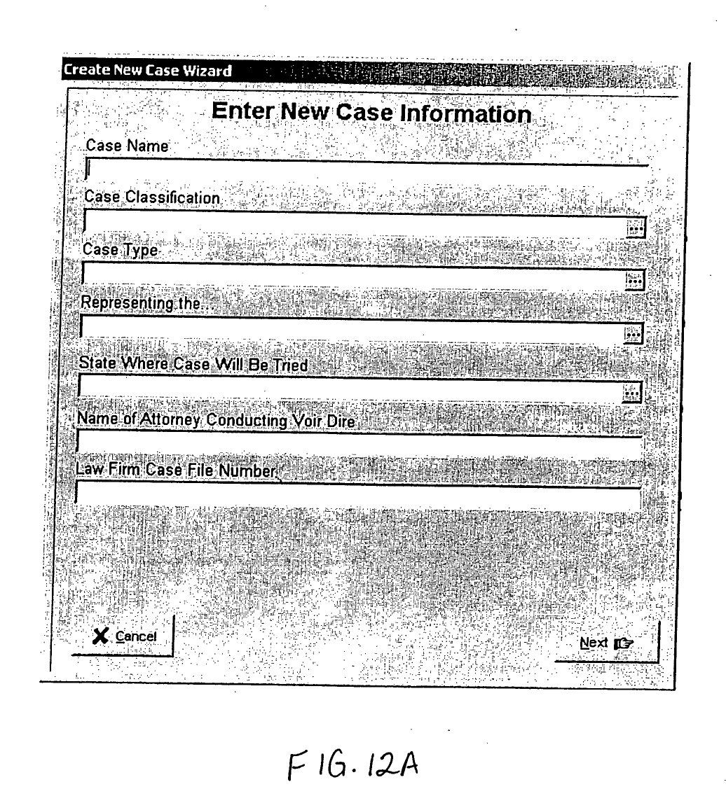

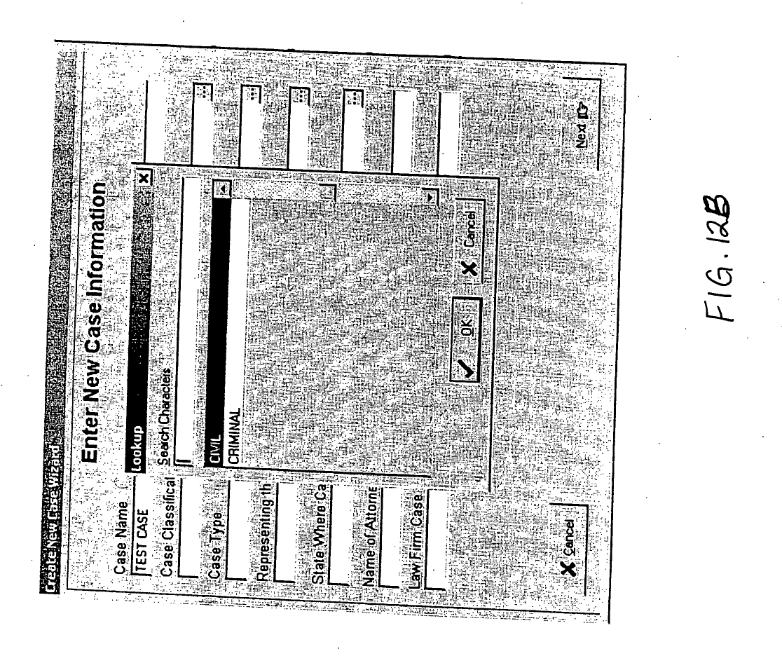

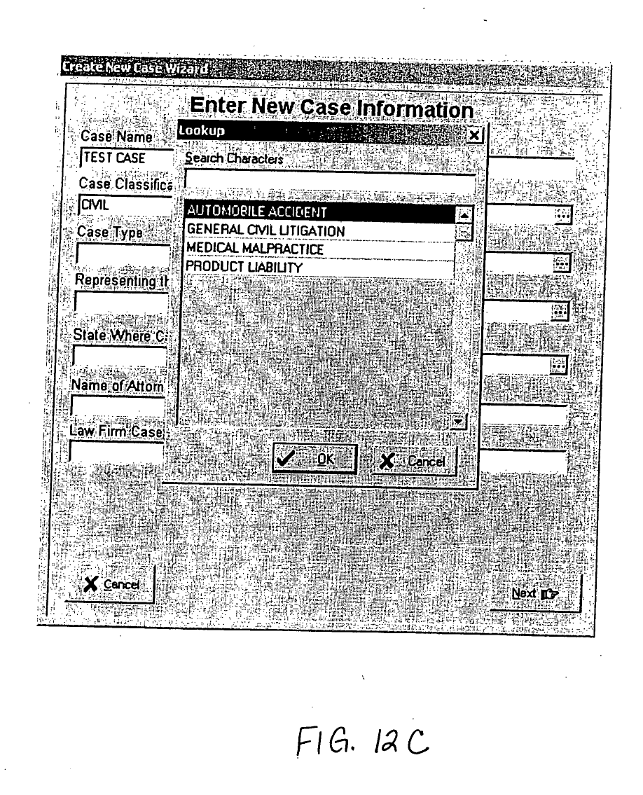

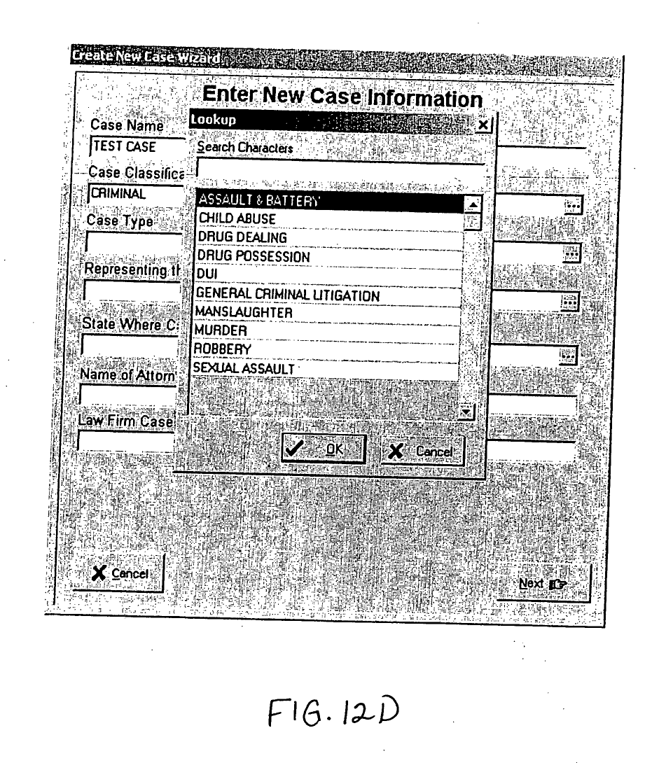

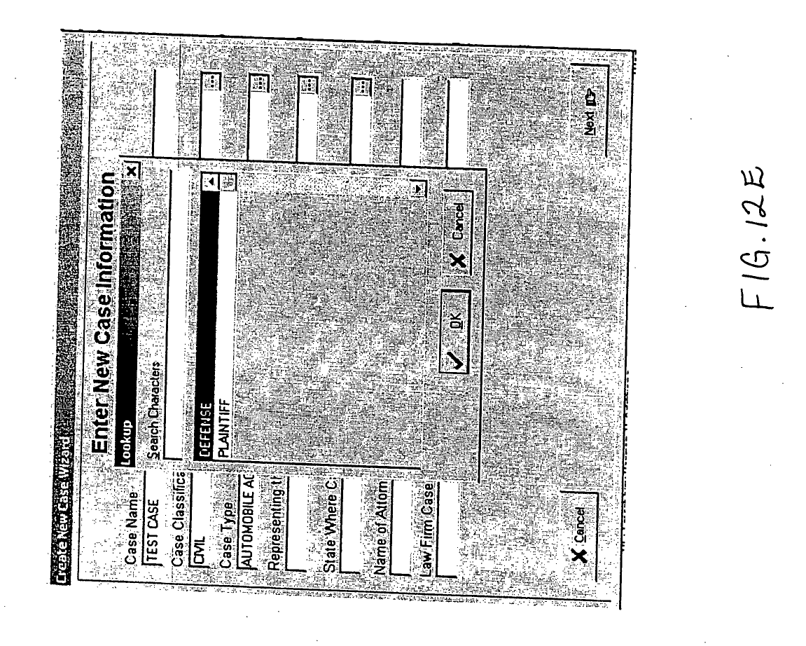

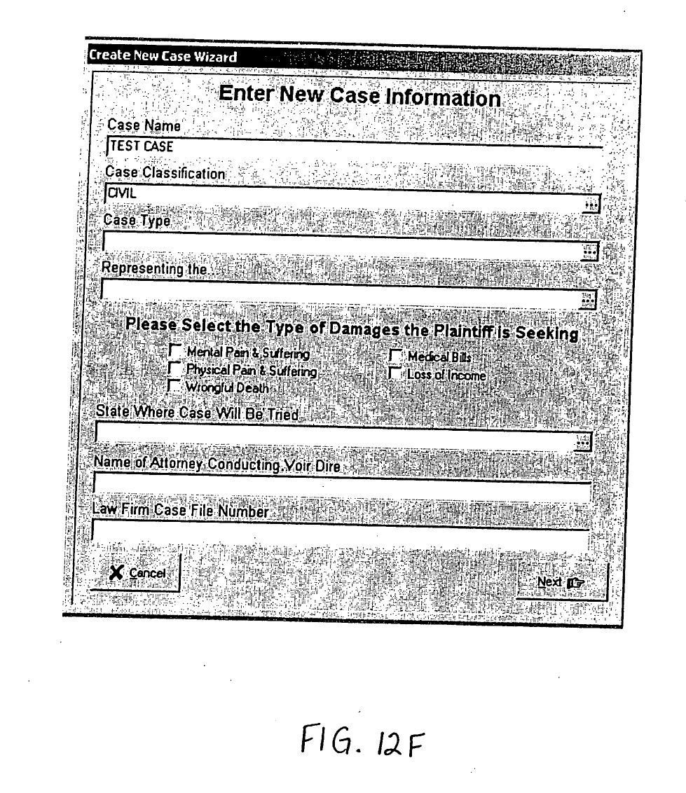

FIG. 3 illustrates further details of the features that may be included in the create new case menu 202 of FIG. 2 to enable a user to create a new case. A user may create a new case by following the exemplary steps outlined in FIG. 3. For instance, a user may initially assign a case name, a case classification, a case type, and the represented party, in Step 302 and shown in FIG. 12A. The case classification enables the user to indicate whether the present lawsuit is either a civil case or a criminal case as shown in FIG. 12B. In Step 303, based upon the case classification entered, a type of case menu enables the user to further classify the type of civil or criminal case (FIGS. 12C-D). In a civil case as illustrated in FIG. 12C, the type of case menu may display one or more selectable icons which represent charges that may be asserted by a plaintiff or against a defendant such as an automobile accident, general civil litigation, medical malpractice and product liability. Similarly, the type of case menu displayed for a criminal case as shown in FIG. 12D may include assault and battery, child abuse, drug dealing and drug possession. As shown in FIG. 12E, the system may also allow the user to indicate whether the user represents either the plaintiff or the defendant. In Step 304, the user may also select the type of damages or penalty to indicate the type of restitution that is being sought in the lawsuit using a menu as shown in FIG. 12F. The type of being damages may be considered in the automatic demographic scoring (ADS) performed by the jury selection management system 200 to select the members of the jury.

Next, in FIG. 3, the user may configure case related information in Step 305 and as shown in FIG. 13A. The case information may allow the user to enter, for example, the lawyer's name and initials, and at least one or more body language observers. The body language observers may be a party's representative who has been assigned the task of monitoring and recording the jurors' body language. The body language observer may be an attorney, a legal assistant and/or a remote viewer, who is monitoring the courtroom events via a satellite communication as discussed above. Thus, the system may receive several body language actions that may be entered simultaneously by multiple observers. Also in Step 305 and as shown in FIG. 13B, the user may enter into the system the laws of the state or foreign jurisdiction which will govern the lawsuit.

In Step 306 shown in FIG. 3, the user may configure the case. In order to configure the case in FIG. 3 and FIG. 14A, the jury selection management system 200 may include an automatic demographic scoring (ADS) which will automatically select which characteristics will mostly likely influence the demographic score and automatically generate a score for each potential juror for each new case. The jury selection management system 200 may also enable a user to manually pre-program the characteristics in determining a manual demographic score (MDS) which may indicate how a potential juror may vote if selected as a member of the jury. The system may be configured so that the automatic demographic scores (ADS) will be calculated and displayed for each potential juror whether or not the user chooses to manually input his or her own demographic letter scores. If the user does manually input letter scores for the characteristics, then the manual demographic score (NDS) will be calculated for each potential juror and displayed separately from the automatic demographic score (ADS).

The user may initially pre-score or rate at least one or more personal characteristics that may be considered a favorable, unfavorable or neutral trait of a potential juror for either the defendant or the plaintiff. For example, as shown in FIGS. 14B-14C, the symbol “D+” may represent a specific characteristic that is strongly favorable for the defendant, the symbol “D−” may represent a specific characteristic that is mildly favorable for the defendant, the symbol “N” may represent a personal characteristic that is neutral to both the defendant and the plaintiff for a specific characteristic, the symbol “P−” may represent a mildly favorable characteristic for the plaintiff, and the symbol “P+” may represent a strongly favorable characteristic for the plaintiff. The symbol “D” may be used to denote a moderately favorable defense oriented characteristic, and the symbol “P” may be used to indicate a moderately favorable plaintiff or prosecution oriented characteristic. For example, the user may manually change the score of the age (FIG. 14B) and income (FIG. 14C) characteristics of the potential jurors if the user believes that a younger juror would be more favorable to the defense or if the user believes that a juror having an income less than $20,000 would be more favorable to the plaintiff. The user may select and change any of the exemplary characteristics shown in FIG. 14A.

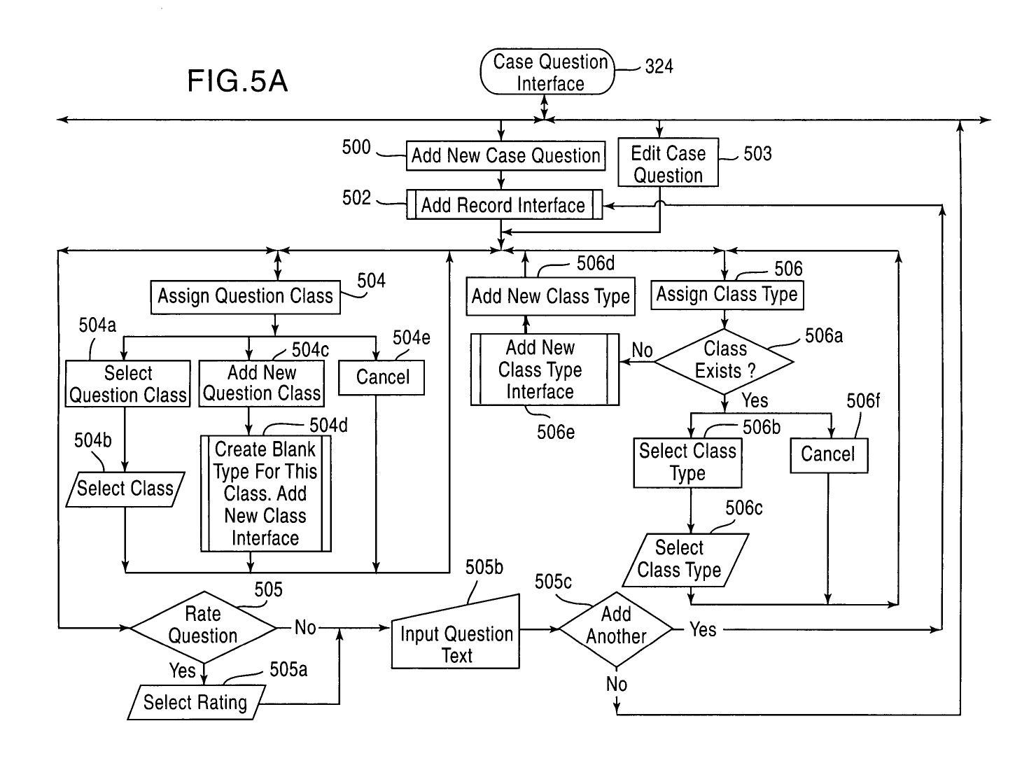

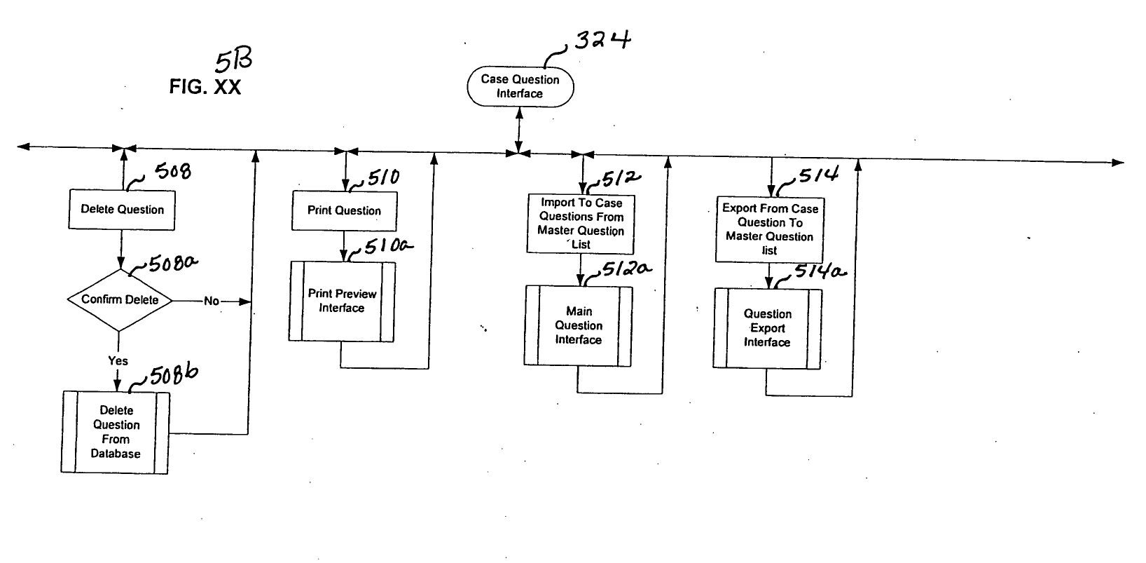

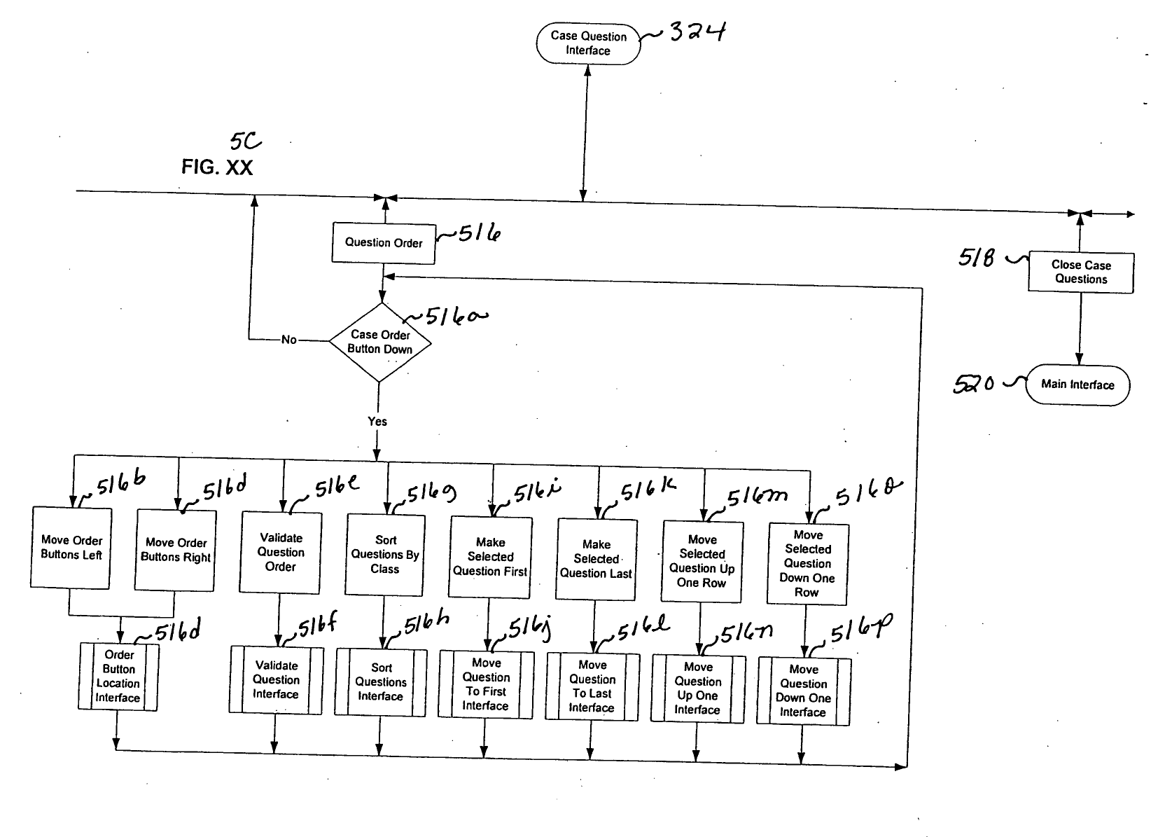

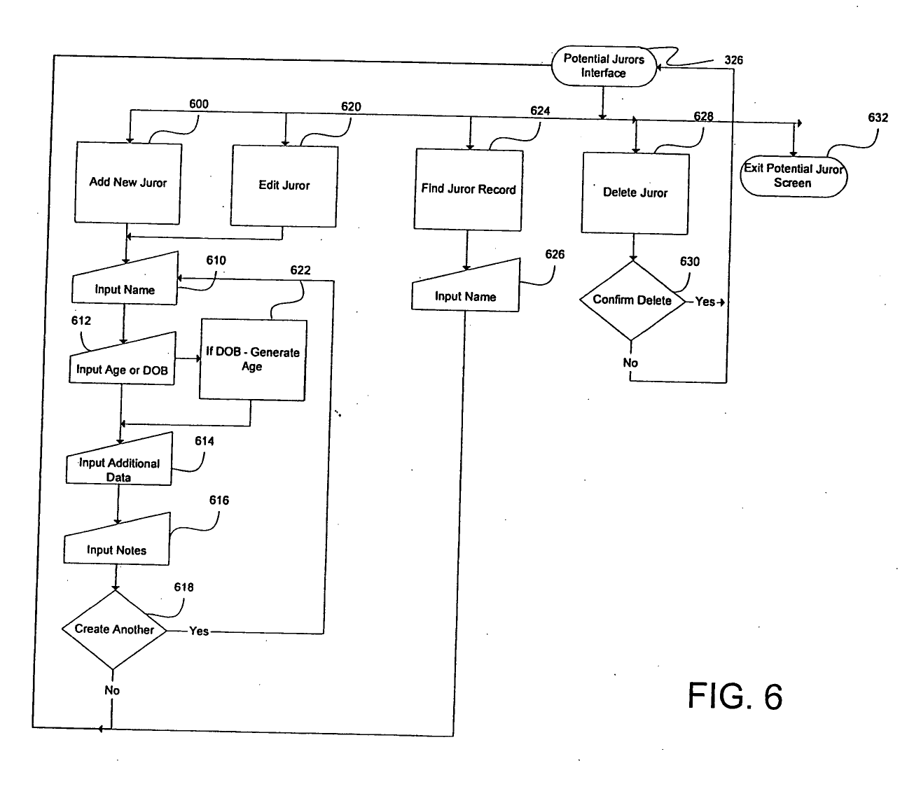

Next, the user may continue to pre-configure the parameters of the new case by setting up the case questions in Step 322 of FIGS. 3 and 5A-5C. The case question interface 324 may allow the user to import and/or manually enter questions that may be asked of the potential jurors during the voir dire. The user may also pre-configure the new case so that the questions selected or generated may be assigned a score (FIG. 15D). Based upon the type of case and the damages or restitution sought, the system may also automatically generate automatic demographic scoring (ADS) questions which are directly related to the demographic characteristics shown in FIG. 15D.

FIGS. 5A-5C provide further details of the setup case questions Step 322 and case question interface Step 324 in FIG. 3. In FIG. 5A, the case question interface 324 may allow the user to add a new question to the new case in Step 500 by activating an add record interface 502. The system may also allow the user to edit a previously generated question in Step 503, to assign question class 504 and to assign class type 506. In FIGS. 5B-5C, the system may further allow the user to delete questions 508, print questions 510, import questions to case questions from a case question list or a master question list 512, to export questions from the case master question list 514 and to arrange the question order 516.

In Step 504 and as shown in FIG. 5A, the user may select the class of the question 504a-504b. The user may select a class of questions from a case list or a master question list (FIG. 15B). The master question list may contain questions that have been previously drafted and stored in the jury selection management system 200. The jury selection management system 200 may also allow the user to establish a connection to the Internet, to another computer or to another electronic device and perform database searches to assist the user in creating the case question list. The class of the question may be directed to a “general” question that may be presented to all the members of the juror pool, as illustrated in FIG. 15C. New question classification may be added to the case question interface in Steps 504c-504e. The user may also rate one or more questions in Steps 505-505c.

In Steps 505-505c, each question may be assigned a score using the rating system. For example, in FIG. 15D, the age question, “Could you please state your age?” and the education question, “How many of you have received any training or education in the law?” have been assigned plaintiff favorable ratings which are indicated by the symbol “P+.” Step 505b may provide the user with a text box to input question text. Step 505c may allow the user to add another question to the new case.

In addition, the user may assign a class type to a question. The user may initially check the system in Step 506a to determine whether the class exists in Step 506a. If the class type exists, the user may select the class type in Steps 506b-506c. If the class type does not exist, the user may add a new case in Steps 506d-506e. After selecting the class type and/or adding a new class type, the user may cancel the assign class type in Step 506f.

The delete question button, in Step 508 in FIG. 10B, may allow a user to select one or more questions and delete these selected questions. The confirm delete button in Step 508a may be provided as a safety precautionary measure to prevent the user from inadvertently deleting a question. The delete question button provided in Step 508b may be included in the system to allow the user to quickly delete all previously stored questions from the database.

In Step 510-510a, the case question interface also may enable the user to perform administrative features such as print out a listing of the questions that the user has selected and compiled for a particular case. Activation of the print button in Step 510 may instruct computer system 100 to establish a communication with a device such as printer, scanner or a facsimile machine in order to generate a printout of the selected questions. The print preview interface 510a may allow the user to preview the questions on display 112 before generating a printout.

The master question list import 512-512a may allow the user to import questions for a particular case from the master question list. The master question list export 514-514a may allow the user to export questions that have been generated for a particular case from that particular case to the master question list. Questions stored in the master question interface may be assigned a class and a class type. Questions may also be added to or deleted from the master question list.

The jury selection management system 200 may also be configured to enable the user to rearrange the order in which the questions are displayed on display 112 in Steps 516-516p. The user may activate selectable representations to move the order button left and right (Steps 516b-516d). The newly arranged order of questions may be validated by the user in Steps 516e-516f. The order of the questions may be sorted based upon the class in Steps 516g-516h. The system also enables the user to quickly rearrange the order of the questions so that a selected question is moved to the first question (Steps 516i-516j), the selected question is moved to the last question (Steps 516k-5161), the selected question is moved up one row (Steps 516m-516n) and/or the selected question is moved down one row (Steps 516o-516p). The change of order feature in Step 516 may allow the user to arrange the questions in advance of the trial. The change of order feature in Step 516 may also be used dynamically during the jury selection process to arrange the questions as the events occur within the courtroom. The user may also use the change of order feature to arrange and assign the order of questions that are presented to each potential juror. Once the user has selected and formatted the questions, the user may exit the case question interface in Step 518 and return to the main interface in Step 520 to setup the venire panel (Step 325) in FIG. 3.

As discussed above, prior to the jury selection process, each party may receive, from the court, a list containing the names, for example, of approximately 300 potential jurors. The setup venire panel in Step 325 and the potential juror interface, in Step 326 in FIG. 3, may allow the user to enter the names of the potential jurors and perform a background check on each potential juror in advance of and during the jury selection process. The system may use the potential juror interface shown in FIGS. 3, 6 and 16A-16C to input information (Step 600 and shown, for example, in FIG. 16B) such as a potential juror's name (Step 610), age (Step 612) or any other additional information deemed pertinent to the case (Step 614). In Step 612, the user may enter either the potential juror's age or date of birth. In Step 622, the system will automatically calculate the potential juror's age if the user enters the date of birth in Step 612. The jury selection management system may also permit the user to add notes or comments regarding each potential juror. The system may be configured so that entry of the potential juror's information in Step 618 may be an iterative process. The potential juror's information may be entered into the system manually, electronically or through a wireless communication connection. For example, a user may manually type in a potential juror's information. Alternatively or in conjunction, the potential juror's information may be entered through a connection established via the Internet or with another electronic device. The potential juror's information may also be sent from a wireless communication device and downloaded automatically to the jury selection management system 200. The system may then generate a listing of the names of potential jurors. Once a potential juror's information has been entered into the system, Step 620 may allow the user to edit the potential juror's information. The system may provide the user with a similar screen display as shown, for example, in FIG. 16B to enable the user to edit the potential juror's information in Step 620.

The system may also permit a user to search a juror list database to locate a juror's records in Step 624 by entering a juror's name in Step 626. This feature may enable the system to maintain a database of previously selected jurors or potential jurors. If the name of a potential juror, who has previously served on a jury, participated in a juror selection process or participated in any aspect of a legal case in any jurisdiction, appears on the list for the juror pool in a subsequent case, the jury selection management system 200 may automatically search a database and retrieve all information previously stored regarding this potential juror. For instance, the jury selection management system 200 may retrieve any statements, body language gestures, or votes made by the potential juror in a previous case.

The jury selection management system 200 may access one or more private or public databases to search for information regarding a potential juror. The jury selection management system 200 may provide a collective database, which may be searched to locate information regarding a particular potential juror. The collective database may be established by compiling several juror databases generated by one or more users in various jurisdictions. For example, if a potential juror in a Florida case served on a jury in North Carolina and voted against a pharmacy company, the jury selection management system 200 may be able to retrieve and add this information to the potential juror information, as shown in FIG. 16B. The system may automatically populate and insert the information within the corresponding fields shown in FIGS. 16B-16C. Alternatively, the information shown in FIGS. 16B-16C may be manually entered into the system, as discussed above. Based upon the type of case and damages sought, the system may automatically highlight or flag the fields which may be the most important or influential in predicting the most accurate automatic demographic score (ADS) or manual demographic score (MDS).

Step 628 may permit the user to delete any juror from the juror database, and Step 630 may serve as a safety precaution for preventing the user from accidentally deleting a juror's information. Step 632 may be provided by the system to allow the user to exit the potential juror screen and return to the seating chart configuration in Step 328 in FIG. 3.

In FIG. 3 in Step 328 and FIGS. 17A-17B, the jury selection management system may allow the user to quickly configure any possible seating arrangement for any number of jurors. By selecting the seating chart button in Step 328, the system may automatically activate a seating chart configuration interface in Step 330. The seating chart configuration interface in Step 330 may allow the user to develop a seating chart. After the potential juror's seating arrangement has been assigned, if any of the potential jurors are asked to leave the juror panel, change seats or if the seating arrangement is altered for any reasons, the jury selection management system 200 may enable the user to dynamically rearrange the seating arrangement within the virtual seating chart.

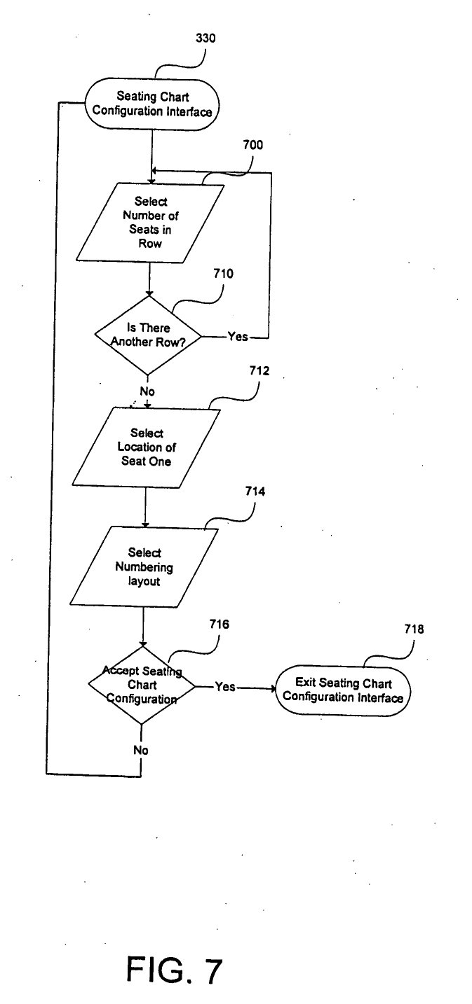

FIG. 7 provides further details of the setup seating chart arrangement (Steps 328-330). In Step 700 of FIG. 7, as the judge assigns the seating arrangement, the user may define the number of seats that may be assigned to each row. For example as shown in FIG. 17B, if the judge instructs that there will be four potential jurors seated on the first row, five potential jurors seated on the second row, four potential jurors seated on the third row and five potential jurors seated on the fourth row, the user may automatically select the appropriate number of seats in Step 700. The user may continue to select as many rows as needed in Step 710.

Step 712 may allow the user to initiate the setup of the numbering layout by defining the location of the first seat, i.e. “seat one” as arranged by the judge. The system may use the “seat one” position to plot the numbering layout for the remaining seats in Step 714. In FIG. 17B, the numbering layout starting from “seat one” may be configured to resemble, for example, a zigzag configuration, several horizontal rows extending either left-to-right or right-to-left, several vertical rows extending either front to back or back to front or any other configuration. The user may accept the seating chart configuration in Step 716. The user may exit the seating chart configuration in Step 718 and return to the main case interface 1000 as shown in FIG. 3.

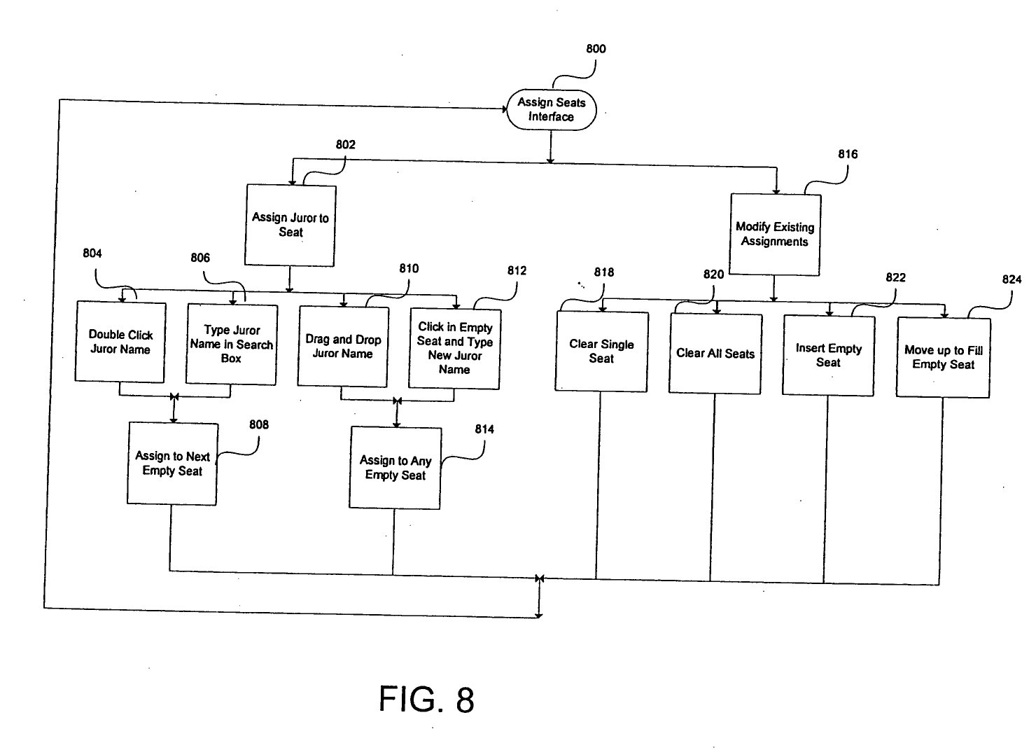

During the jury selection process as the potential jurors enter the courtroom, the user may automatically configure each potential juror's seating assignment by using the assign seat interface in Steps 800 and 802 in FIG. 8 and illustrated in FIG. 18A. As the potential jurors take their seats, the juror selection management system may allow the user to automatically select a user's name previously entered into the system (Steps 804, 806 and 810) or to manually enter a juror's name (Step 812) into a corresponding box on the display screen 112, as shown in FIGS. 18A and 18B. The user may assign the potential juror to any available seat in Step 814 by dragging the potential juror's name from a selectable representation and moving the juror's name to an empty box representation in Steps 810 and 814. Alternatively, the user may merely click on an empty box representation and type in the potential juror's name in Steps 812 and 814.

If the positions of the jurors change for any reasons after the judge has established the original seating arrangement, the user may prompt the system to quickly modify the existing seating arrangement in Step 816. The system may provide the user with several ways to modify the existing seating arrangement. For example as illustrated in FIG. 18A, the user may clear a single seat (Step 818), clear all seats (Step 820), insert an empty seat (Step 822) and/or move all potential juror's positions to fill an empty seat (Step 824).

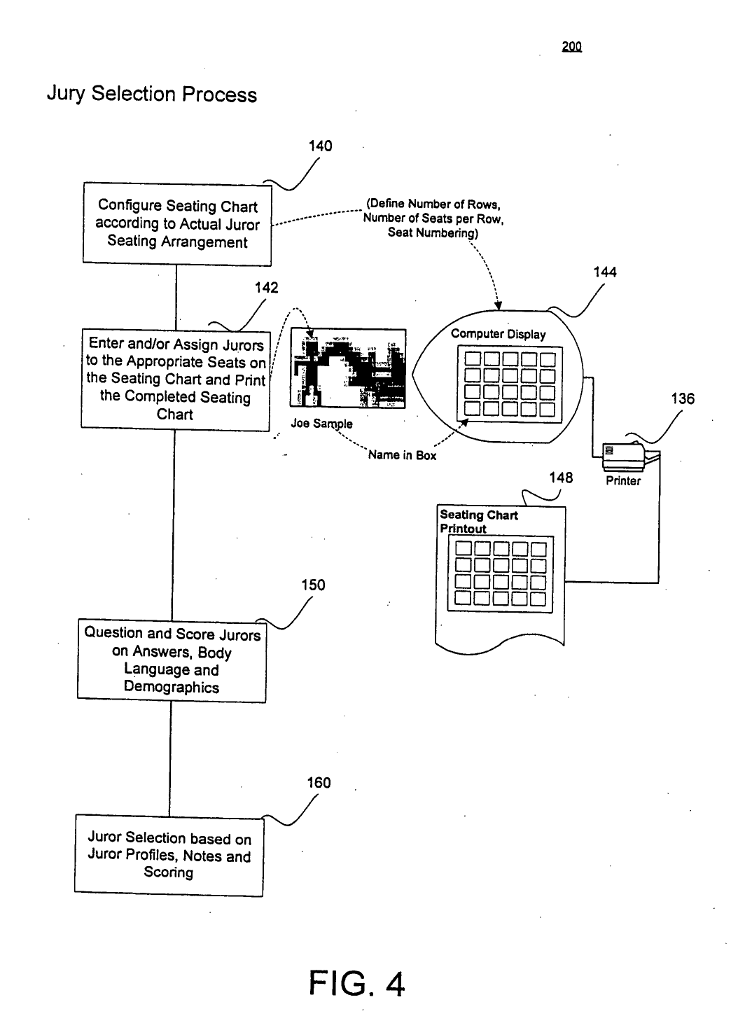

In comparison to FIG. 4, FIG. 3 illustrates a new case created using both the pre-selection process and the jury selection process. Meanwhile, FIG. 4 illustrates a new case created using only the jury selection process. During operation of the jury selection process in FIG. 4, the user may decide to bypass several of the pre-selection preparation features of the main interface 201 and to quickly access the features of the main case interface 1000. Several features implemented in the main case interface 1000 during the jury selection process shown in FIGS. 4 and 10A-10C may be similar to some of the features available in the main interface 201.

FIG. 4 may represent an outline of some of the general tasks that the user may use the jury selection management system 200 to perform automatically and dynamically during the jury selection process. For instance, in Step 140, the user may configure a seating chart according to the actual potential juror seating arrangement as assigned by the judge. The user may enter and/or assign the potential jurors to the appropriate seats in the seating chart, in Step 142. The system may provide a computer-generated display of the seating chart in Step 144. The user may instruct the system to establish a communication link with a printer in Step 136 in order to generate a printout of the seating chart including the names of each potential juror in Step 148.

In Step 150, the user may generate questions for the potential juror during the jury selection process. Based upon the jurors' answers, response to the questions and demographics, the user may assign a score to the potential juror and/or the jury selection management system 200 may assign a score to the potential juror. The user may then in Step 160 select the members of the jury based upon the juror's profile, attach notes to a potential juror's information and review the score assigned to each potential juror.

FIGS. 10A-10C provide further details of the process depicted in FIG. 4. In FIGS. 10A-10B, the main case interface 1000 may be displayed on display 112 having one or more selectable representations as shown in FIGS. 19A-19B. FIGS. 19A-19B illustrate examples of a display screen that a user may use during the jury selection process. The selectable representations shown in FIGS. 19A-19B may include, for example, an assign seats button (Step 1002 in FIG. 10A), an answers button (Step 1006 in FIG. 10A), a potential jurors button (Step 1010 in FIG. 10A), a case questions button (Step 1014 in FIG. 10A), a configure case button (Step 1018 in FIG. 10A), a print menu (Step 1022 in FIG. 10A) and a configure chart button (Step 1026 in FIG. 10A). The term “button” as used in this discussion may mean “a selectable object in a computer that instructs the computer to perform a task, such as display a subsequent screen, activate an interface or perform a calculation, when the button is clicked or activated.” The user may select the assign seats button, which in turn activates the assign juror seats interface in Step 1004. The assign juror seats interface (Step 1004) may allow the user to assign potential jurors to locations in the seating chart as outlined in FIG. 8 and illustrated in FIGS. 18A-18B.

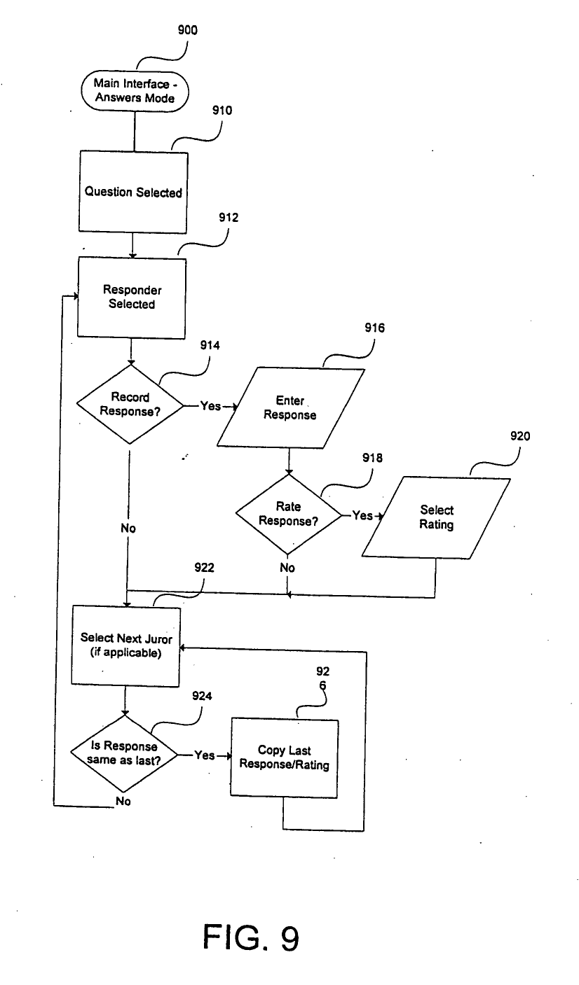

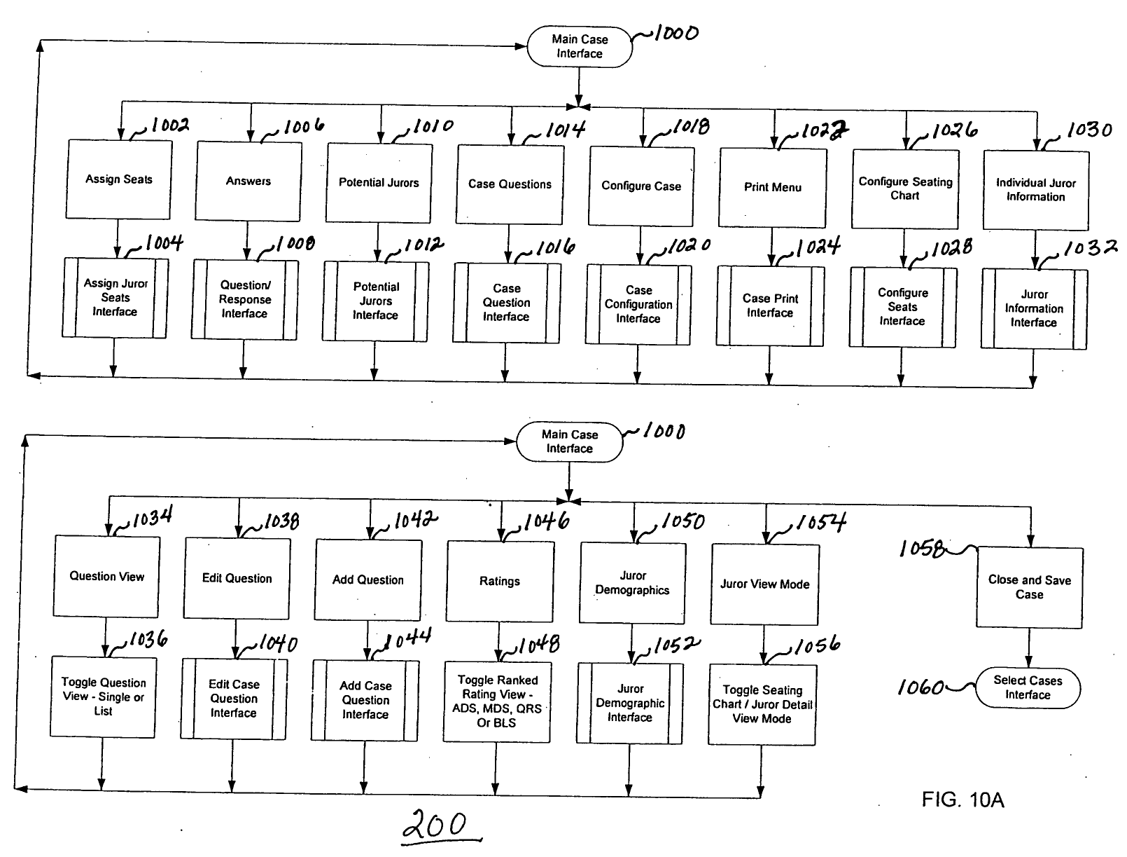

The answers button in Step 1006 may allow the user to record and grade any responses received from the potential jurors, as discussed with reference to FIG. 9 and illustrated in FIGS. 19A-19B as a recording answers menu. Favorable responses, unusual answers, and relationships that might affect the potential juror's decision may be quickly and clearly entered and scored using the question/response interface in Step 1008 as shown in the display shown in FIG. 19E.

FIG. 9 provides further details of the answers and the question/response interface in Steps 1006-1008 in FIG. 10A. Once the voir dire process begins, the user may enter the question mode in order to rate and grade the responses received from the potential jurors in Step 900 shown in FIG. 9. The user may select, in Step 910, the question to be asked from the question database. The user may select, in Step 912, the potential juror who responds to the question. The respondent may be selected by selecting the potential juror's corresponding seat as shown on the display 112 in FIG. 19A. The user may either manually or electronically record the potential juror's response in Step 916. Step 916 may allow the user to save the potential juror's response.

In Step 918 and as shown in FIG. 19H, the user may rate or grade the potential juror's response by assigning, for example, a letter grade which may represent a number grade on a grade scale. If the user wishes to grade the potential juror's response in Step 918, the user may use the grading scale depicted in FIGS. 14B-14C to grade or rate each response in Step 920. The system, as shown in FIG. 19A, may allow the user to designate that several jurors have responded to the same question in Step 922. For example, if a defense attorney asks a general question directed to the entire juror pool and if three members of the juror pool answers affirmatively, in Step 922, the user may select the applicable jurors. When there are several jurors that provide the same response to the same question, Step 924 may allow the user to select these potential jurors and copy the last response and rating to several potential jurors in Step 926. Custom answers may also be entered into the system if a potential juror provides a response which is of particular interest to the user as shown in FIG. 19E. The potential juror's response can be entered and automatically scored.

Returning to FIG. 10A, the potential juror button in Step 1010 may allow the user to enter the potential juror's name and other relevant information by selecting the juror profile menu in FIGS. 19A, 19B and 19C. The potential jurors interface in Step 1012 may use a similar process as explained above with reference to FIG. 6 and illustrated in FIGS. 16A-16C to compile personal information regarding each potential juror.

The user may select the case question button in Step 1014 to formulate questions that may be presented to the entire juror panel or to a particular potential juror by activating the voir dire question menu shown at the bottom of the display screen in FIGS. 19A-19B. The user may choose from hundreds of predefined or user created case-appropriate questions and quickly import the questions from a master question list into a numbered case question list that can be used in questioning the potential juror as shown in FIGS. 15D-15E and outlined in FIGS. 5A-5C. The question list can be modified, added to and printed out at any time. In Steps 1014-1016, the system may use the method discussed in FIG. 5C to permit the user to quickly arrange the questions according to categories, rate the question and designate a question to be directed to a particular potential juror or the entire juror panel.

In the main case interface 1000 in Step 1018, the system may follow Steps 302-306 outlined in FIG. 3A to configure the case. By selecting the configure case button in Step 1018, the case configuration interface 1020 may be initiated to enter general information regarding the name of the case, the names of the parties involved in the case and the attorney's name. The case configuration interface 1020 may be activated by the system to assign a rating to each demographic group or personal characteristic of the jurors as shown in FIGS. 14A-14C. The case configuration interface 1020 may be used to rate personal characteristics or demographics of the potential jurors.

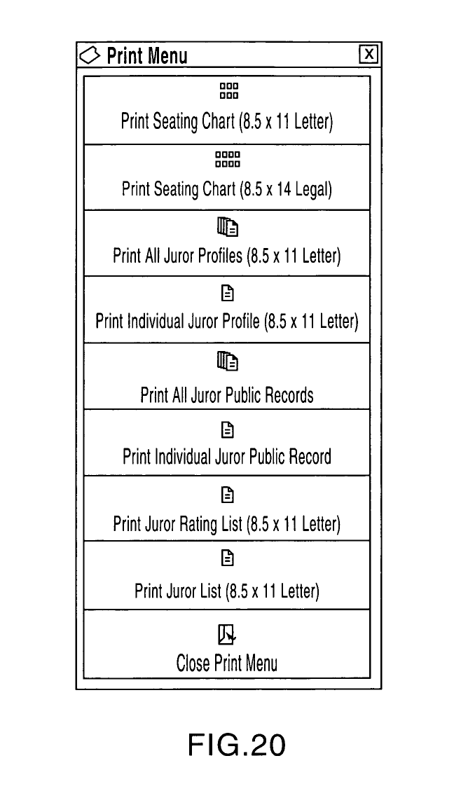

At any time, the user may select the print menu in Step 1022 in FIG. 10A to generate a printout of several types of information generated by the jury selection management system 200. In Step 1024 and as shown in FIG. 20, the case print interface 1024 may permit the user to receive a printout of information such as the seating chart, a profile of all of the jurors, a profile of an individual juror, a printout of all of the jurors public records, a printout of an individual juror's public record, a juror rating list, and a juror list. The print juror profile button may allow the user to print the ADS scores, the MDS scores, the QRS scores and the BLS scores for each individual juror as shown for example in FIG. 19H or as shown in FIG. 19J.

To configure the seating chart in Step 1026, the main case interface may implement the steps outlined in FIG. 7 and depicted in FIG. 17B and FIGS. 18A-18B. The jury selection management system 200 may employ the configure seats interface 1028 to construct a virtual seating chart during the jury selection process. The jury selection management system 200 in Steps 1026-1028 may automatically configure any possible seating arrangement for any possible number of jurors. The system may also be used during a trial to dynamically construct a virtual jury box and replicate the seating position of any other participant in the courtroom such as the judge, opposing counsel and any courtroom employee.

In Steps 1030 of main case interface 1000, the system may employ steps similar to the steps 600-620 outlined in FIG. 6 to use the juror information interface in Step 1032 to enter personal characteristic information about each juror. During the jury selection process, the user may select the question view menu in Step 1034 to activate the question view interface in Step 1034 so that the user and/or members of his or her team can view the questions to be asked during the voir dire individually or in a list format. The system may allow the user in Step 1036 to toggle between a single question and a list of questions.

As the events unfold in the courtroom, should the user wish to edit or add a new question to the case list questions or the master question list database, the user may select the edit question menu in Step 1038 or the add new question menu in Step 1042. Activation of the edit question menu in Step 1038 may automatically initiate the edit case question interface in Step 1040 and activation of the add new question menu in Step 1042 may automatically initiate an add case question interface in Step 1044, which may utilize similar steps as discussed in FIGS. 5A-5C to implement the functions in Steps 1038-1044.

In addition, the jury selection management system 200 may allow the user at anytime during the jury selection process to automatically rate the potential jurors based upon the scores or ratings such as the ADS ratings, the MDS ratings, the QRS ratings, and the BLS ratings entered regarding each potential juror. As shown in FIG. 19B, the system may provide, for example, both plaintiff MDS ratings and defendant MDS ratings. The plaintiff ratings may provide a list according to the jurors who are more favorable to the plaintiff. The plaintiff list may be arranged based upon several factors such as the potential juror having the highest score that is most favorable to the plaintiff, the potential juror having the lowest score, a particular demographic, and/or by the potential jurors name. Likewise, a defendant rating may be automatically generated as shown in FIG. 19B.

A ratings menu may be selected in Step 1046 to initiate the toggle ranked ratings view in Step 1048. The ranked rating view may permit the user to view a listing of potential jurors sorted by the jury selection system 200 generated score. Furthermore, in FIG. 19B, the score for each potential juror may automatically be calculated by the system any time an entry is made or a potential juror provides a response that is entered in the system that alters the potential juror's rating. The show ADS score menu shown in FIG. 19B may be activated by the user to display the defense ADS ratings score and the plaintiff ADS ratings score. As discussed above, the system automatically calculates the automatic demographic score (ADS) based upon the demographic information which may be collected during the pre-selection process and/or during the jury selection process in comparison with the survey data. Likewise, the show MDS score menu in FIG. 19B may be activated by the user to display the defense and plaintiff manual demographic score (MDS). The show BLS (body language score) score menu shown in FIG. 19B may be selected to display the score tallied for the potential jurors based upon their body language observed and entered into the system. The show QRS (question response score) score menu in FIG. 19B may be selected to reveal the score generated based upon the responses or answers provided by the potential jurors. Furthermore, since the system may be employed during real-time, any response provided by the potential jurors during the questioning phase which adds, alters or deletes the demographic information, the system will automatically recalculate the automatic demographic score (ADS) and the manual demographic score (MDS).

Referring back to FIG. 10A, the user may select, in Steps 1050-1052, the juror demographics menu to score certain demographic or personal characteristics by selecting the configure demographic menu shown in FIGS. 19A, 19B and 19F. The configure demographics menu shown, for example, at the bottom of the screen in FIG. 19B may be used by the user to manipulate the demographic factors.

In FIG. 10A, the juror view mode menu 1054 may be selected by the user to rapidly toggle the view from the seating chart generated in Steps 800-824 (FIG. 8) and/or Steps 1002-1004 (FIG. 10A) to a detailed view of a single juror. The juror view mode menu may also enable the user to view information regarding a particular potential juror. In particular, selection of the juror view mode menu may automatically toggle the seating chart/juror detail view mode in Step 1056.

Any changes or modification made by the user in the main case interface can be saved by selecting the close and save feature in Step 1058. The user may return to the cases interface in Step 1060.

FIG. 10B illustrates additional features that may be included within the main case interface 1000. A juror question response score (QRS) override option in Step 1061 may be provided to enable the user to override all rates automatically assigned by the jury selection management system 200 to the maximum score awarded to either the plaintiff/prosecution or defense. Regardless of the answers and responses provided by a potential juror if the potential juror demonstrates a predisposition that indicates that the potential juror is partial to either side, the override feature may be implemented, for example, to override the rating assigned to all responses received from that particular potential juror in Step 1062. The system may permit the user to select another juror and to override ratings assigned to one or more jurors in Step 1063. If activated, the QRS override feature may automatically change the question response score (QRS) for a potential juror to either D+ (most favorable to the defense) or P+ (most favorable to the plaintiff). For example, if one or more jurors based upon their demeanor show a preference to either party, the user could flag these jurors by assigning them the maximum score associated with the respective party through the use of the QRS score override interface 1064.

In Steps 1065-1068, the jury selection management system 200 may also allow a user to flag a juror's body language such as a roll of the eyes, or a nod to an attorney's remark. Any significant body language may result in a symbol being entered and displayed next to a particular juror's name or in the box assigned to a particular juror in the seating chart. By activating the body language menu shown in FIGS. 19A-19B, the user may enter any body language that may occur, for example, during the selection process, during breaks provided during the selection process, or as the potential jurors enter the courtroom as shown in FIG. 19I. The body language feature in Steps 1065-1068 may also be used to record the body language of the potential jurors, as well as the body language of any participant of the case such as the judge, any member of the opposing party, as well as any member of the audience. The system can be used as a peer-to-peer network where multiple users can view and observe the jurors or any other courtroom event and simultaneously enter the observations within the system as a body language and a body language score. The body language score (BLS) may appear for a potential juror on the display screen as shown in FIG. 19B.

In Steps 1069-1072 in FIG. 10B, the user may instruct the system to conduct a background search of a potential juror during the jury selection process in order to compile personal information regarding each potential juror. Activation of the potential juror interface 1072 by selecting the public records select menu shown for example in FIG. 19B may automatically cause the jury selection management system 200 to perform a background search on any potential juror who is added to the potential juror listing. Activating the public record select menu allows the user to automatically access a public or private database and retrieve any information about a potential juror that may be available via public records as shown in FIG. 19G.

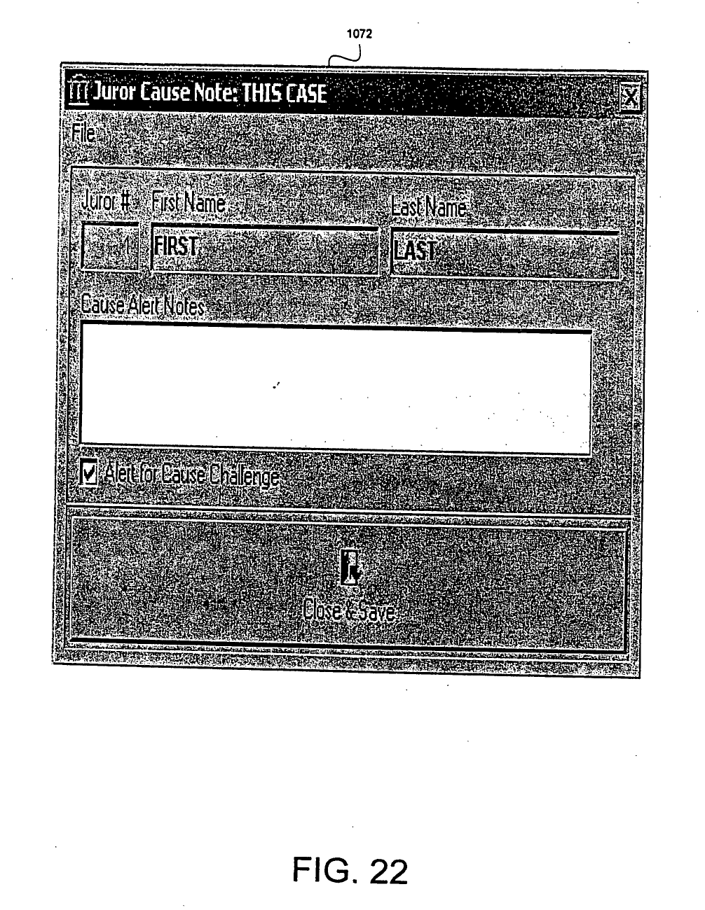

Another aspect of the invention may include a cause alert feature, which can be implemented in Steps 1073-1076. If a party believes that someone in the courtroom has made a statement that justifies a challenge for cause, the user can record the cause for challenge manually, as shown in FIG. 22. Alternatively, the user may activate a selectable feature or symbol listed on a pre-programmed menu of challenges to enter the challenge. A symbol such as a “C” may be selected and entered into the box which represents a particular potential juror as shown in FIG. 21. Once a challenge is entered and its description has been added into the system in Step 1075, as discussed above, the jury selection management system 200 may automatically initiate a search of a case law database to support the challenge. Step 1076 may enable the user to enter a cause for challenge for several different jurors or participant of the case or to enter multiple causes for challenge for a single potential juror or participant of the case.

As shown in FIG. 10B, Steps 1077-1082 may enable the user to add a QRS rating or modify a QRS rating assigned to a particular potential juror.

A note box may be provided as a feature of the system that enables the user to quickly enter any notes or comments regarding a particular juror into the system in Steps 1084-1091 in FIG. 10C and FIG. 19D. The add note interface in Step 1091 may permit a user to enter notes in each box representing a member of the juror panel by activating the add note menu shown in FIGS. 19A, 19B and 19D. In addition in Steps 1092-1095 if a potential juror has been selected for a peremptory strike by either the defendant or plaintiff, the system may be configured to automatically monitor and record the number of peremptory strikes assigned by either party. As the user approaches the maximum number of peremptory strikes permitted for the jurisdiction in which the case is being conducted, the system may also warn the user of the number of peremptory strikes already assigned and alert the user of the remaining number of peremptory strikes permitted by the jurisdiction. To designate those jurors that have been dismissed by the plaintiff/prosecution in Steps 1092-1095, the user may select the plaintiff/prosecution peremptory menu shown in FIG. 19B. Likewise, to designate those jurors that have been dismissed by the defense in Steps 1096-1099, the user may select the defendant peremptory menu shown in FIG. 19B.

In Steps 1100-1103, the selected jurors menu shown in FIG. 19B may be activated so that the system monitors and records the names and number of jurors that have been designated to serve on the jury. Similarly, in Steps 1104-1107, the user may select the alternate jurors menu shown in FIG. 19B so that the system monitors and records the names and number of jurors that have been designed to serve as an alternate juror. Furthermore, by selecting the menus, such as the plaintiff/prosecution peremptory menu, the defendant peremptory menu, the cause strike menu, the selected juror menu, the alternate juror menu and the alternate button, the user may cause the system to generate a quick reference list of the potential jurors whom have been designated to these respective categories. For example, by activating the cause strike menu, the system may generate a list of all the potential jurors whom were stricken for cause.

In general, the jury selection management system 200 provides a party in a legal dispute with a method and apparatus for automatically ranking the potential jurors based upon how the jurors have responded to the questions. The jury selection management system 200 may also provide pre-programmed factoring based upon each potential juror's demographics and body language. The jury selection management system 200 may also enable a user to compile demographic information and conduct a survey. Based upon a comparison between the compiled demographic information and the survey, the system may generate indicators which may predict how a potential juror will vote in the outcome of the legal dispute. The system may automatically combine all the recorded information and assign a ranking to the members of the jury panel. After the ranking has been generated, the system may provide a quick overview of each potential juror, his or her responses, body language and or demographics in order to assist a party in determining whether a potential juror's score is high enough or low enough to be selected as a member of the jury. Furthermore, the jury selection management system 200 may also aid the user to determine the likely foreman of the jury.

One having ordinary skill in the art will readily understand that the steps of the method may be performed in different order, or with multiple steps in parallel with one another. Also, one having ordinary skill in the art will understand that a network device may be configured to perform the above-described method either in silicon or in software. Accordingly, one will understand that the switching configurations described herein are merely exemplary. Accordingly, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A selection system for selecting at least one candidate from a group of potential candidates, said selection system comprising:
a survey database configured to store statistical data;
a candidate database configured to store potential candidate information regarding at least one candidate; and
a processor in communication with said survey database and said candidate database, said processor configured to perform a comparison between said statistical data and said candidate information and select at least one candidate from a group of potential candidates based upon said comparison.

2. The selection system as recited in claim 1, wherein said survey database is further configured to store statistical data for at least one selection parameter, wherein said at least one selection parameter is used to select said at least one candidate from said group of potential candidates.

3. The selection system as recited in claim 2, wherein said survey database is further configured to assign a score to said at least one selection parameter.

4. The selection system as recited in claim 3, wherein said candidate database is further configured to store candidate information related to said at least one selection parameter.

5. The selection system as recited in claim 4, wherein said candidate database is further configured to store potential candidate information regarding a potential juror for selecting at least one juror from a jury pool.

6. The selection system as recited in claim 5, wherein said survey database is further configured to assign said score to said at least one selection parameter based upon a type of legal case pending before said jury pool and a type of damages requested in said legal case.

7. The selection system as recited in claim 6, wherein said processor is further configured to generate a body language score based upon at least one body language expressed by said potential juror.

8. The selection system as recited in claim 7, wherein said at least one body language is expressed by said potential juror in response to a question directed to said potential juror during a voir dire.

9. The selection system as recited in claim 6, wherein said processor is further configured to generate a statistical score based upon a response provided by said potential juror during a voir dire compared to said statistical data stored within said survey database.

10. The selection system as recited in claim 6, wherein said processor is further configured to generate a manual response score based upon a response provided by said potential juror during a voir dire.

11. The selection system as recited in claim 6, wherein said processor is further configured to generate a question response score based upon a score assigned to a question directed to said potential juror in comparison to a response provided by said potential juror in responding to said question.

12. The selection system as recited in claim 6, wherein said processor is further configured to generate a body language score, a statistical score, a manual response score and a question response score.

13. A method of using a computer to select at least one candidate from a group of potential candidates, the method comprising:
storing statistical data;
storing potential candidate information regarding at least one candidate;
processing said statistical data and said potential candidate information to perform a comparison between said statistical data and said candidate information; and
selecting at least one candidate from a group of potential candidates based upon said comparison.

14. The method as recited in claim 13, wherein said storing said statistical data further comprises storing at least one selection parameter, and using said at least one selection parameter to select said at least one candidate from said group of potential candidates.

15. The method as recited in claim 14, wherein said storing said statistical data further comprises assigning a score to said at least one selection parameter.

16. The method as recited in claim 15, wherein said storing said potential candidate information further comprises storing candidate information related to said at least one selection parameter.

17. The method as recited in claim 16, wherein said storing said potential candidate information further comprises storing potential candidate information regarding a potential juror for selecting at least one juror from a jury pool.

18. The method as recited in claim 17, wherein said storing said statistical data further comprises assigning said score to said at least one selection parameter based upon at least one of a type of legal case pending before said jury pool and a type of damages requested in said legal case.

19. The method as recited in claim 16, wherein said processing further comprises generating a body language score based upon at least one body language expressed by said potential juror.

20. The method as recited in claim 19, wherein said generating said body language score is generated in response to at least one body language expressed by said potential juror in response to a question directed to said potential juror during a voir dire.

21. The method as recited in claim 16, wherein said processing further comprises generating a statistical score based upon a response provided by said potential juror during a voir dire compared to said statistical data stored within said survey database.

22. The method as recited in claim 16, wherein said processing further comprises generating a manual response score based upon a response provided by said potential juror during a voir dire.

23. The method as recited in claim 16, wherein said processing further comprises generating a question response score based upon a score assigned to a question directed to said potential juror in comparison to a response provided by said potential juror in response to said question.

24. The method as recited in claim 16, wherein said processing further comprises generating a body language score, a statistical score, a manual response score and a question response score.

25. A selection system for selection at least one candidate from a group of potential candidates, said selection system comprising:
first storing means for storing statistical data;
second storing means for storing potential candidate information regarding at least one candidate;
processing means for processing said statistical data and said potential candidate information to perform a comparison between said statistical data and said candidate information; and
selecting means for selecting at least one candidate from a group of potential candidates based upon said comparison.

26. The selection system as recited in claim 25, wherein said first storing means is further configured to store at least one selection parameter and use said at least one selection parameter to select said at least one candidate from said group of potential candidates.

27. The selection system as recited in claim 26, wherein said first storing means is further configured to assign a score to said at least one selection parameter.

28. The selection system as recited in claim 27, wherein said second storing means is further configured to store candidate information related to said at least one selection parameter.

29. The selection system as recited in claim 28, wherein said second storing means is further configured to store potential candidate information regarding a potential juror for selecting at least one juror from a jury pool.

30. The selection system as recited in claim 29, wherein said first storing means is further configured to assign said score to said at least one selection parameter based upon a type of legal case pending before said jury pool and a type of damages requested in said legal case.

31. The selection system as recited in claim 30, wherein said processing means is further configured to generate a body language score based upon at least one body language expressed by said potential juror.

32. The selection system as recited in claim 30, wherein said processing means is further configured to generate said body language score is generated in response to at least one body language expressed by said potential juror in response to a question directed to said potential juror during a voir dire.

33. The selection system as recited in claim 30, wherein said processing means is further configured to generate a statistical score based upon a response provided by said potential juror during a voir dire compared to said statistical data stored within said survey database.

34. The selection system as recited in claim 30, wherein said processing means is further configured to generate a manual response score based upon a response provided by said potential juror during a voir dire.

35. The selection system as recited in claim 30, wherein said processing means is further configured to generate a question response score based upon a score assigned to a question directed to said potential juror in comparison to a response provided by said potential juror in response to said question.

36. The selection system as recited in claim 30, wherein said processing means is further configured to generate a body language score, a statistical score, a manual response score and a question response score.

37. The selection system as recited in claim 29, wherein said first storing means is further configured to automatically select said at least one selection parameter based upon a type of legal case pending and a type of damages requested to indicate demographic characteristics that predict an automatic demographic score or a manual demographic score.
